(19) United States
(12) Patent Application Publication
(10) Pub. No.: US 2026/0217996 A1
(43) Pub. Date: Jul. 30, 2026

(54) INK, INK SET, IMAGE FORMING METHOD, AND IMAGE FORMING APPARATUS

(71) Applicants: Hiroshi GOTOU, Shizuoka (JP); Yuta NAKAMURA, Tokyo (JP); Shunsuke HORIE, Kanagawa (JP); Ayaka MATSUMOTO, Kanagawa (JP)

(72) Inventors: Hiroshi GOTOU, Shizuoka (JP); Yuta NAKAMURA, Tokyo (JP); Shunsuke HORIE, Kanagawa (JP); Ayaka MATSUMOTO, Kanagawa (JP)

(21) Appl. No.: 19/461,720

(22) Filed: Jan. 28, 2026

(30) Foreign Application Priority Data
Jan. 28, 2025 (JP) 2025-012216

(51) Int. Cl. C09D 11/30; B41J 2/21; B41J 11/00

(52) U.S. Cl. CPC C09D 11/30; B41J 2/2114; B41J 11/0015

(57) ABSTRACT

An ink contains a coloring material that contains a first resin having a glass transition temperature of at most 0 degrees Celsius, a second resin having a glass transition temperature of at least 60 degrees Celsius, a cation-based polyethylene wax, and water, wherein the first resin contains a solid content of 0.5 to 3 percent by mass based on a total amount of the ink and the second resin contains a solid content of 5 to 15 percent by mass based on a total amount of the ink.

### CROSS-REFERENCE TO RELATED APPLICATIONS

This patent application is based on and claims priority pursuant to 35 U.S.C. § 119 to Japanese Patent Application No. 2025-012216 filed on Jan. 28, 2025, in the Japan Patent Office, the entire disclosure of which is hereby incorporated by reference herein.

### BACKGROUND

### Technical Field

The present disclosure relates to an ink, an ink set, an image forming method, and an image forming device.

### Description of the Related Art

In an inkjet recording method, a small amount of ink droplets is discharged from fine nozzles and deposited onto a recording medium, typically paper, to form text and images. Inkjet printers employing this method are relatively quiet, have a simple process, and allow easy color printing, which has led to their widespread use in home printers. The inkjet recording method has also been adopted for commercial printing applications because of its capability for high-speed printing.

As an ink used in inkjet recording methods, aqueous pigment inks in which pigments are made into fine particles and dispersed in water are known. Since the pigments have a composition similar to colorants used in general commercial printing inks, it is expected that the printed matter can achieve a texture close to that of commercial printing. However, when printing on coated paper widely used for commercial or publishing printing, the use of aqueous pigment inks presents issues such as image areas being transferred to the opposite sheet in the roll state during the winding process, and insufficient abrasion resistance of the image areas.

### SUMMARY

The present disclosure described herein provides an ink that contains a coloring material that contains a first resin having a glass transition temperature of at most 0 degrees Celsius, a second resin having a glass transition temperature of at least 60 degrees Celsius, a cation-based polyethylene wax, and water, wherein the first resin contains a solid content of 0.5 to 3 percent by mass based on a total amount of the ink and the second resin contains a solid content of 5 to 15 percent by mass based on the total amount of the ink.

As another aspect of the present disclosure, an ink set is provided which contains the ink mentioned above and a pre-processing fluid containing water and a flocculant, wherein the flocculant is selected from the group consisting of an inorganic metal salt, an organic acid metal salt, an organic ammonium salt, and a cationic polymer.

As another aspect of the present disclosure, an image forming method is provided which includes applying at least one member selected from the group consisting of heat, pressure, vibration, and light to the ink mentioned above to jet the ink to form an image.

As another aspect of the present disclosure, an image forming apparatus is provided which includes an inkjetting device for applying at least one member selected from the group consisting of heat, pressure, vibration, and light to the ink mentioned above to jet the ink to form an image.

### BRIEF DESCRIPTION OF THE SEVERAL VIEWS OF THE DRAWINGS

A more complete appreciation of the disclosure and many of the attended advantages and features thereof can be readily obtained and understood from the following detailed description with reference to the accompanying drawings wherein:

FIG. 1 is a diagram illustrating an example of the recording apparatus using the ink of the present disclosure;

FIG. 2 is a diagram illustrating a perspective view of a tank that accommodates the ink of the present disclosure;

FIG. 3 is a diagram illustrating a cross sectional view of an example of a recording apparatus using the ink of the present disclosure; and

FIG. 4 is a diagram illustrating a cross sectional view of another example of a recording device using the ink of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more the features, integers, steps, operations, elements, components, and/or groups thereof.

Embodiments of the present invention are described in detail below with reference to accompanying drawings. In describing embodiments illustrates in the drawings, specific terminology is employed for the sake of clarity. However, the disclosure of this patent specification is not intended to be limited to the specific terminology so selected. And it is to be understood that each specific element includes all technical equivalents that have a similar function, operates in a similar manner, and achieve a smaller result.

For the sake of simplicity, the same reference number will be given to identical constituent elements such as parts and materials having the same functions and redundant descriptions thereof omitted unless otherwise stated.

Within the context of the present disclosure, it a first layer is stated to be “overlaid” on, or “overlying” a second layer, the first layer may be in direct contact with a portion or all of the second layer, or there may be one or more intervening layers between the first and second layer, with the second layer being close to the substrate than the first layer.

The present disclosure provides an ink capable of forming high-quality images with excellent abrasion resistance on general-purpose paper as well as plain paper.

### Ink

The ink of the present disclosure contains a coloring material, a resin, a wax, a surfactant, and water, and may also contain other optional components. Each component of the ink is described below.

### Coloring Material

The coloring material has no particular limitation and includes such materials as a pigment and a dye. Of the two, pigments are preferably used in terms of weatherability.

The pigment is typified into organic pigments and inorganic pigments.

Specific examples of the inorganic pigments include, but are not limited to, titanium oxide, iron oxide, calcium oxide, barium sulfate, aluminum hydroxide, barium yellow, cadmium red, chrome yellow, and carbon black. Of these, carbon black is preferable.

Carbon black (Pigment Black 7) can be manufactured by a known method such as a contact method, a furnace method, and a thermal method. Specific examples include, but are not limited to, channel black, furnace black, gas black, and lamp black.

Examples of carbon black commercially available are Black Pearls®, Elftex®, Monarch®, Regal®, Mogul®, and Vulcan®. Specific examples include, but are not limited to, Black Pearls 2000, Black Pearls 1400, Black Pearls 1300, Black Pearls 1100, Black Pearls 1000, Black Pearls 900, Black Pearls 880, Black Pearls 800, Black Pearls 700, Black Pearls 570, Black Pearls L, Elftex 8, Monarch 1400, Monarch 1300, Monarch 1100, Monarch 1000, Monarch 900, Monarch 880, Monarch 800, Monarch 700, Mogul L, Regal 330, Regal 400, Regal 660, and Vulcan P (all available from Cabot Corporation), SENSIJET Black SDP100 (available form SENSIENT), SENSIJET Black SDP 1000 (available from SENSIENT), and SENSIJET Black SDP 2000 (available from SENSIENT). These can be used alone or in combination.

Specific examples of the organic pigments include, but are not limited to, azo pigments, polycyclic pigments, dye chelate, nitro pigments, nitroso pigments, and aniline black. Among these, azo pigments and polycyclic pigments are preferable.

Specific examples of the azo pigments include, but are not limited to, azo lake, insoluble azo pigments, azo pigment condensates, and chelate azo pigments.

Specific examples of the polycyclic pigments include, but are not limited to, phthalocyanine pigments, perylene pigments, perinone pigments, anthraquinone pigments, quinacridone pigments, dioxazine pigments, indigo pigments, thioindigo pigments, isoindolinone pigments, and quinofuranone pigments. The dye chelate includes, but are not limited to, basic dye type chelate, and acidic dye type chelate.

Specific examples of the organic pigment include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 128, 139, 150, 151, 153, 155, 180, 183, 185 and 213; C.I. Pigment Orange 5, 13, 16, 17, 36, 43, and 51; C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 185, 190, 193, 209, and 219; C.I. Pigment Violet 1 (Rohdamine Lake), 3, 5:1, 16, 19, 23, and 38; C.I. Pigment Blue 1, 2, 15 (Phthalocyanine Blue), 15:1, 15:2, 15:3 (Phthalocyanine Blue), 16, 17:1, 56, 60, and 63; and C.I. Pigment Green 1, 4, 7, 8, 10, 17, 18, and 36. These can be used alone or in combination.

The specific surface area of the pigment has no particular limitation and can be suitably selected according to a particular application. For example, the specific surface area is preferably from 10 to 1,500 m²/g, more preferably from 20 to 600 m²/g, and furthermore preferably from 50 to 300 m²/g.

Unless a pigment having such a suitable surface area is available, it is possible to reduce the size of the pigment or pulverize it by using, for example, a ball mill, a jet mill, or ultrasonic wave for the pigment to obtain a relatively small particle diameter.

The 50 percent cumulative volume particle diameter (D₅₀) of the pigment is preferably from 10 to 200 nm in ink.

The pigment is preferably a water-dispersible pigment. As the water-dispersible pigment, for example, (1). Surfactant dispersion pigment in which a pigment is dispersed by a surfactant, (2). A resin dispersion pigment in which a pigment is dispersed by a resin, (3). A resin coated dispersion pigment in which the surface of a pigment is covered with a resin, and (4). A self-dispersible pigment in which a hydrophilic group is provided to the surface of a pigment are suitable.

Of these, in terms of storage stability over time and reduction of viscosity increase at the time of water evaporation, (3). A resin coated dispersion pigment in which the surface of a pigment is covered with a resin, and (4). A self-dispersible pigment in which a hydrophilic group is provided to the surface of a pigment are preferable.

As the resin coated pigment dispersion of (3) mentioned above in which the surface of a pigment is coated with a resin, resin emulsion in which a pigment is contained in a resin particle is preferable.

The resin emulsion in which a pigment is contained in a resin particle means an article in which the pigment is encapsulated in the resin particle or adsorbed on the surface of the resin particle. In this case, it is not necessary for all of the pigments to be encapsulated or adsorbed, and the pigments may be dispersed in the emulsion insofar as the effect of the present disclosure is not impaired.

Specific examples of resins contained in resin fine particles forming the resin emulsions include, but are not limited to, vinyl-based resins, polyester-based resins, and polyurethane-based resins. Among these, vinyl-based resins and polyester-based resins are particularly preferable, and examples of such resins are disclosed in Japanese Unexamined Patent Application Publication Nos. 2000-53897 and 2001-139849.

The content of the coloring agent to the total amount of ink is preferably from 1 to 15 percent by mass and more preferably from 2 to 10 percent by mass. If the content is at least 1 percent by mass, the ink exhibits adequate color development and image density. When the content is at most 15 percent by mass, the ink does not become excessively viscous, thereby preventing deterioration in ink discharge. This is also preferable from an economic standpoint.

### Resin

The resin is preferably in the form of an emulsion. The resin emulsion exhibits excellent film-forming properties, chemical resistance, water resistance, and weather resistance. It also improves fixability because the emulsion does not readily swell in the presence of a solvent added to the ink due to its excellent chemical resistance. In addition, this excellent water resistance contributes to forming images with high image density and excellent color development.

It is preferable that the resin be added to the ink in the form of a resin emulsion. Accordingly, the present disclosure contains the resin as a resin emulsion having the same polarity charge as the pigment.

The resin in the present disclosure is preferably an acrylic resin or a urethane resin, and an acrylic resin containing at least acrylic acid and methacrylic acid and a urethane resin containing urethane bonds can be used.

The acrylic resin and urethane resin are not particularly limited as long as they have water dispersibility and may be appropriately selected according to a particular application. From the viewpoint of preventing adhesion to a general inkjet head (having a nozzle plate with a water repellent film), it is preferable that the resin be an anionic resin having anionic functional groups such as carboxyl groups, sulfonic groups, and hydroxyl groups.

If the ink set of the present disclosure includes a pre-processing liquid described later, it is preferable that at least one member selected from the resin and the coloring agent is anionic. If at least one selected from the resin and the coloring material is anionic and the ink comes into contact with the pre-processing liquid containing a flocculant, the ink can be caused to aggregate or thicken, and as a result, adhesion of the ink to the surface of the recording medium can be enhanced, which is preferable.

There are no particular restrictions on the shape of the resin, and it can be suitably selected according to a particular application, whether it is regular or irregular. Of these, regular shapes are preferable.

If the resin has a regular shape, it is preferably spherical. In the case of a spherical resin, it is preferable for it to be in the form of particles.

### First Resin and Second Resin

The ink of the present disclosure contains, as resin components, two types of resins having different glass transition points (Tg): a first resin and a second resin.

The first resin has a glass transition temperature (Tg) of at most 0 degrees Celsius, and the solid content of the first resin is 0.5 to 3 percent by mass based on the total amount of the ink. When the solid content of the first resin is at least 0.5 percent by mass based on the total amount of the ink, the abrasion resistance of image areas formed with the ink is improved. Further, if the solid content of the first resin is at most 3 percent by mass based on the total amount of the ink, the image areas exhibit excellent blocking resistance.

The glass transition temperature (Tg) of the first resin is preferably −45 to 0 degrees Celsius.

Adding the first resin having a glass transition temperature (Tg) within the above range to the ink enhances the abrasion resistance of images formed with the ink.

The second resin has a glass transition temperature (Tg) of at least 60 degrees Celsius, and the solid content of the second resin is 5 to 15 percent by mass based on the total amount of the ink. If the solid content of the second resin is at least 5 percent by mass based on the total amount of the ink, the abrasion resistance of image areas formed with the ink is improved. Further, if the solid content of the second resin is at most 15 percent by mass based on the total amount of the ink, the ink exhibits good storage stability and discharge stability. If the solid content of the second resin exceeds 15 percent by mass based on the total amount of the ink, the storage stability and discharge stability of the ink may deteriorate.

The glass transition temperature (Tg) of the second resin is at least 60 degrees Celsius, and preferably 60 to 100 degrees Celsius. Adding the second resin having a glass transition temperature (Tg) within the above range to the ink improves the storage stability of the ink and the blocking resistance of image areas.

The glass transition temperature (Tg) of the resin is measurable, for example, using a DSC-60A Plus equipped with a cooling unit, available from Shimadzu Corporation.

The volume average particle diameter of the resin emulsion is not particularly limited and can be suitably selected according to a particular application, it is preferably from 10 to 150 nm and preferably from 35 to 100 nm. If the volume average particle diameter of the resin is at least 10 nm, its abrasion resistance is excellent, making it preferable. If the volume-average particle diameter of the resin is at most 150 nm, its filter permeability is excellent, making it preferable.

The volume average particle diameter of the resin emulsion is measurable using a device such as a particle size analyzer (Nanotrac Wave II-UT151, available from MicrotracBEL Corp.).

The resin emulsion may be of a self-emulsifying type in which a hydrophilic component for stable dispersion in water is introduced, or it may be of a type that becomes water-dispersible through the use of an external emulsifier. The resin emulsion can be synthesized or procured.

Specific examples of procurable acrylic resins for use in the first resin include, but are not limited to, TOCRYL BCX-8111 (Tg: −30 degrees Celsius), TOCRYL W-168 (Tg: −10 degrees Celsius), and TOCRYL X-4403 (Tg: −7 degrees Celsius) (all manufactured by Artience Co., Ltd.; “TOCRYL” is a registered trademark), as well as Hiros-X PE-2109 (Tg: −10 degrees Celsius, volume average particle diameter: 100 nm), Hiros-X TE-1336 (Tg: −34 degrees Celsius, volume average particle diameter: 150 nm), Hiros-X JE-1113 (Tg: −24 degrees Celsius, volume average particle diameter: 60 nm), and Hiros-X RE-2108 (Tg: −37 degrees Celsius, volume average particle diameter: 80 nm) (all manufactured by Seiko PMC Corporation; “Hiros” is a registered trademark).

Specific examples of commercially available urethane resins for use in the first resin include, but are not limited to, UCoat UX-300 (Tg: −25 degrees Celsius, volume-average particle diameter: 120 nm), UCoat UX-310 (Tg: −25 degrees Celsius, volume-average particle diameter: 120 nm), UCoat UX-340 (Tg: −50 degrees Celsius, volume-average particle diameter: 50 nm), PERMARIN UA-150 (Tg: −70 degrees Celsius, volume-average particle diameter: 70 nm), PERMARIN UA-200 (Tg: −35 degrees Celsius, volume-average particle diameter: 70 nm), PERMARIN UA-350 (Tg: −30 degrees Celsius, volume-average particle diameter: 70 nm), PERMARIN UA-368 (Tg: −20 degrees Celsius, volume-average particle diameter: 300 nm), UCoat UWS-145 (Tg: −45 degrees Celsius, volume-average particle diameter: 20 nm), and UPRENE UXA-307 (Tg: −45 degrees Celsius, volume-average particle diameter: 200 nm) (all manufactured by Sanyo Chemical Industries, Ltd.; “UCoat,” “PERMARIN,” and “UPRENE” are registered trademarks), as well as Superflex 300 (Tg: −42 degrees Celsius, volume-average particle diameter: 70 nm, solid content: 30 percent by mass), Superflex 420 (Tg: −10 degrees Celsius, volume-average particle diameter: 10 nm, solid content: 32 percent by mass), Superflex 420NS (Tg: −10 degrees Celsius, volume-average particle diameter: 10 nm), Superflex 460 (Tg: −21 degrees Celsius, volume-average particle diameter: 40 nm, solid content: 38 percent by mass), Superflex 460S (Tg: −28 degrees Celsius, volume-average particle diameter: 30 nm), Superflex 470 (Tg: −31 degrees Celsius, volume-average particle diameter: 50 nm, solid content: 38 percent by mass), Superflex 500M (Tg: −39 degrees Celsius, volume-average particle diameter: 140 nm, solid content: 45 percent by mass), and Superflex 740 (Tg: −34 degrees Celsius, volume-average particle diameter: 200 nm, solid content: 40 percent by mass) (all manufactured by Dai-ichi Kogyo Seiyaku Co., Ltd.; “Superflex” is a registered trademark), as well as UPRENE WS-6021 (Tg: −60 degrees Celsius, volume-average particle diameter: 90 nm, solid content: 30 percent by mass) and TAKELAC W-6110 (Tg: −20 degrees Celsius, volume-average particle diameter: 90 nm, solid content: 32 percent by mass) (both manufactured by Mitsui Chemicals, Inc.; “TAKELAC” is a registered trademark).

Specific examples of commercially available acrylic resins for use in the second resin include, but are not limited to, TOCRYL W-3080 (Tg: 70 degrees Celsius, volume-average particle diameter: 100 nm, manufactured by Artience Co., Ltd.), Hiros-X KE-1062 (Tg: 96 degrees Celsius, volume-average particle diameter: 80 nm), Hiros-X NE-2270 (Tg: 73 degrees Celsius, volume-average particle diameter: 160 nm), and Hiros-X JE-1056 (Tg: 82 degrees Celsius, volume-average particle diameter: 50 nm) (all manufactured by Seiko PMC Corporation).

Specific examples of commercially available urethane resins for use in the second resin include, but are not limited to, Superflex 130 (Tg: 101 degrees Celsius, volume-average particle diameter: 30 nm), Superflex 170 (Tg: 75 degrees Celsius, volume-average particle diameter: 10 nm, solid content: 33 percent by mass), Superflex 830HS (Tg: 68 degrees Celsius, volume-average particle diameter: 10 nm, solid content: 27 percent by mass), and Superflex 870 (Tg: 78 degrees Celsius, volume-average particle diameter: 30 nm, solid content: 30 percent by mass) (all manufactured by DKS Co. Ltd.), as well as TAKELAC W-5030 (Tg: 85 degrees Celsius, volume-average particle diameter: 50 nm), TAKELAC W-5661 (Tg: 70 degrees Celsius, volume-average particle diameter: 30 nm, solid content: 35 percent by mass), TAKELAC WS-5984 (Tg: 70 degrees Celsius, volume-average particle diameter: 80 nm), TAKELAC W-6010 (Tg: 90 degrees Celsius, volume-average particle diameter: 60 nm), TAKELAC W-6020 (Tg: 90 degrees Celsius, volume-average particle diameter: 80 nm, solid content: 30 percent by mass), TAKELAC W-605 (Tg: 100 degrees Celsius, volume-average particle diameter: 80 nm), and TAKELAC W-635 (Tg: 70 degrees Celsius, volume-average particle diameter: 150 nm) (all manufactured by Mitsui Chemicals, Inc.).

### Organic Solvent

The ink of the present disclosure may contain an organic solvent. The organic solvent includes, for example, polyhydric alcohol.

Specific examples of polyhydric alcohols include, but are not limited to, 3-methyl-1,3-butanediol (SP value: 12.05, boiling point: 203 degrees Celsius), 1,2-butanediol (SP value: 12.75, boiling point: 192 degrees Celsius), 1,3-butanediol (SP value: 12.75, boiling point: 207 degrees Celsius), 1,4-butanediol (SP value: 12.95, boiling point: 230 degrees Celsius), 2,3-butanediol (SP value: 12.55, boiling point: 177 degrees Celsius), 1,2-propane-diol (SP value: 13.48, boiling point: 188.2 degrees Celsius), 1,3-propane-diol (SP value: 13.72, boiling point: 214 degrees Celsius), 1,2-hexanediol (SP value: 11.80, boiling point: 223 degrees Celsius), 1,6-hexanediol (SP value: 11.95, boiling point: 208 degrees Celsius), 3-methyl-1,5-pentanediol (SP value: 11.80, boiling point: 250 degrees Celsius), triethylene glycol (SP value: 12.12, boiling point: 285 degrees Celsius), diethylene glycol (SP value: 13.02, boiling point: 245 degrees Celsius), and glycerin (SP value: 16.38, boiling point: 290 degrees Celsius). These can be used alone or in combination.

Among these, from the viewpoint of ink dryness, organic solvents having a boiling point at 1 atmospheric pressure of at most 200 degrees Celsius, such as 1,2-butanediol (SP value: 12.75, boiling point: 192 degrees Celsius), 2,3-butanediol (SP value: 12.55, boiling point: 177 degrees Celsius), and 1,2-propane-diol (SP value: 13.48, boiling point: 188.2 degrees Celsius), are more preferable.

The total content of the polyhydric alcohols is preferably 5 to 40 percent by mass based on the total amount of the ink. If the content is at least 5 percent by mass, discharge stability is improved, which is preferable. If the content is at most 40 percent by mass, the ink attains an appropriate viscosity and dryness are less likely to deteriorate, which is preferable.

Further, if the ink contains an organic solvent having a solubility parameter of 9 to less than 11.8, it is preferable because the occurrence of beading can be suppressed even on general-purpose printing paper.

The solubility parameter (SP value) is a value indicating how easily both are mutually dissolved in each other. The SP value is represented by an attractive intermolecular force, that is, a square root of cohesive energy density (CED). CED is an amount of energy required to evaporate 1 mL of an article. The unit of the solubility parameter (SP value) is expressed as (cal/cm³)^{1/2}; however, it is omitted in the text.

The solubility parameter (SP value) is defined by the regular solution theory introduced by Hildebrand and indicates the solubility of a two-component system solution. There are theories about the calculation method of SP value. In the present disclosure, a generally-used Fedors method is used. According to Fedors method, the SP value can be calculated using the following Relation (I).

SP value (solubility parameter)=(CED value)^{1/2}=(E/V)^{1/2} Relation (I)

In Relation (I), E represents molecule cohesive energy (cal/mol) and V represents molecular volume (cm³/mol). When the evaporation energy of an atomic group is Δei and the molar volume is Δvi, the values are represented by the following Relation (II) and Relation (III).

$$E = \sum Δ ei \qquad Relation ( II )$$

$$V = \sum Δ vi \qquad Relation ( III )$$

As the calculation method and the data of evaporation energy Δei and the mol volume Δvi of individual atomic groups, the data shown in Imoto, Minoru, Basic Theory of Attachment, chapter five, published by “KOUBUNSHI KAGAKUKAI” can be used.

In addition, regarding articles in which a group such as —CF₃ group is not shown, R. F. Fedors, Polymer Eng. Sci. 14, 147 (1974) can be referred to.

Specific examples of the organic solvents having a solubility parameter (SP value) of 9 to less than 11.8 include, but are not limited to, 1-propoxy-2-propanol (SP value: 9.82, boiling point: 149 degrees Celsius), 1-methoxy-2-propanol (SP value: 10.41, boiling point: 120 degrees Celsius), 1-ethoxy-2-propanol (SP value: 9.98, boiling point: 132 degrees Celsius), 3-methoxy-1-butanol (SP value: 9.98, boiling point: 161 degrees Celsius), 3-methoxy-3-methyl-1-butanol (SP value: 9.64, boiling point: 174 degrees Celsius), diethylene glycol monobutyl ether (SP value: 9.86, boiling point: 231 degrees Celsius), ethylene glycol monobutyl ether (SP value: 9.99, boiling point: 171 degrees Celsius), ethylene glycol monomethyl ether (SP value: 10.73, boiling point: 124 degrees Celsius), diethylene glycol monomethyl ether (SP value: 10.17, boiling point: 193 degrees Celsius), ethylene glycol monoethyl ether (SP value: 10.41, boiling point: 136 degrees Celsius), diethylene glycol monoethyl ether (SP value: 10.14, boiling point: 196 degrees Celsius), and triethylene glycol monomethyl ether (SP value: 10.12, boiling point: 249 degrees Celsius).

The total content of the organic solvents having a solubility parameter (SP value) of 9 to less than 11.8 is preferably 5 to 30 percent by mass based on the total amount of the ink. When the content is at least 5 percent by mass, beading on general printing paper and color bleed between colors can be reduced. When the content is at most 30 percent by mass, good image quality and adequate ink viscosity are achieved, thereby ensuring preferable discharging stability.

As the permeating agent, the solubility parameter is preferably from 9 to less than 11.8. For example, polyol compounds and glycol ether compounds having 8 to 11 carbon atoms are suitable.

Specific examples of the other polyol compounds include, but are not limited to, 2-ethyl-2-methyl-1,3-propanediol, 3,3-dimethyl-1,2-butane diol, 2,2-diethyl-1,3-propane diol, 2-methyl-2-propyl-1,3-propane diol, 2,4-dimethyl-2,4-pentane diol, 2,5-dimethyl-2,5-hexane diol, and 5-hexene-1,2-diol.

The proportion of the permeating agent to the entire of ink is preferably from 0.5 to 4 percent by mass and more preferably from 1 to 3 percent by mass. When the proportion is not less than 0.5 percent by mass, ink suitably permeates a medium, which has a good impact on the image quality. Conversely, when the content is at most 4 percent by mass, initial viscosity of ink becomes suitable.

### Cation-Based Polyethylene Wax

The ink of the present disclosure contains a cation-based polyethylene wax as wax. The inclusion of cation-based polyethylene wax in the ink enhances abrasion resistance of resulting images.

In the present disclosure, the cation-based polyethylene wax refers to an emulsion containing a dispersant having a cationic group and polyethylene wax. The polyethylene wax is a low-molecular-weight polyethylene that is solid at room temperature and melts into a liquid upon heating without decomposition. While the molecular weight of a general polyethylene resin is on the order of tens of thousands to several hundred thousand, the molecular weight of polyethylene wax is about 1,000 to 10,000. The inclusion of a dispersant having a cationic group allows the polyethylene wax to be uniformly dispersed as fine particles in an aqueous solution.

The content of polyethylene wax contained in the cation-based polyethylene wax is 0.1 to 2.0 percent by mass based on the total amount of the ink.

The polyethylene wax is preferably linear.

The particle diameter of the polyethylene wax is preferably from 50 to 500 nm. The particle diameter is measurable using a nanortac particle size analyzer (Nanotrac WaveII-UT151, available from MicrotracMRB Corp.).

The melting point of the polyethylene wax is preferably between 100 degrees Celsius and 140 degrees Celsius. The melting point is measurable using differential scanning calorimeter (DSC) measurement.

The degree of crystallinity of the polyethylene wax is preferably from 50 to 99 percent. The degree of crystallinity is measurable using differential scanning calorimeter (DSC) measurement.

Specific examples of commercially available polyethylene wax include, but are not limited to, Hi-WAX 4052E (melting point: 110 degrees Celsius), Hi-WAX 405MP (melting point: 121 degrees Celsius), and Hi-WAX 400P (melting point: 126 degrees Celsius) (all manufactured by Mitsui Chemicals, Inc.), which can be suitably used.

As the dispersant having a cationic group, a cationic surfactant is preferred. Specific examples of cationic surfactants include, but are not limited to, dialkylbenzyl ammonium chloride, lauryltrimethyl ammonium chloride, alkylbenzyl methyl ammonium chloride, alkylbenzyl dimethyl ammonium bromide, benzalkonium chloride, cetylpyridinium bromide, alkyltrimethyl ammonium bromide, halide salts of quaternary polyoxyethyl alkylamine, and dodecylbenzyltriethyl ammonium chloride.

The content of the cationic surfactant is not particularly limited and may be appropriately selected according to a particular application. From the viewpoint of producing a stable emulsion of cation-based polyethylene wax, it is preferably 0.1 to 15 percent by mass, more preferably 1.0 to 5.0 percent by mass, based on the total amount of the cationic surfactant and the cation-based polyethylene wax.

The emulsion of cation-based polyethylene wax can be prepared, for example, by the following method. Polyethylene wax, a cationic surfactant, and an aqueous medium are mixed in a vessel at a temperature equal to or higher than the melting point of the polyethylene wax to form an emulsified product. The emulsified product is then cooled to ambient temperature at a cooling rate of at least 10 degrees Celsius per minute. When the temperature exceeds 100 degrees Celsius, it is preferable to apply pressure to the vessel so that the aqueous component inside the vessel remains in a liquid state.

As an apparatus for preparing an emulsion of cation-based polyethylene wax, a pressure-type homogenizer is preferred; for example, a reactor equipped with a jacket capable of heating and water cooling, such as model LAB2000 manufactured by SMT Co., Ltd., is suitably used.

When polyethylene wax, a cationic surfactant, and water are mixed together in the reactor, other components such as a compatibilizer may also be added.

The heating temperature for forming the emulsified product is preferably at least 10 degrees Celsius higher than the melting point of the polyethylene wax. At this time, as the heating temperature becomes higher, the particle size of the polyethylene wax becomes smaller.

From the viewpoint of improving heating efficiency, it is preferable to use a reactor that can be sealed and operated at a pressure higher than atmospheric pressure and that has a circulation system.

### Other Surfactant

The ink of the present disclosure further contains other surfactants in addition to the cationic-based surfactant.

It is preferable to contain a polyether-modified siloxane compound as one of the other surfactants.

The inclusion of the polyether-modified siloxane compound as the other surfactant reduces wetting of the ink on the ink-repellent film of the nozzle plate in the ink head. Consequently, defective discharge caused by ink adhesion to the nozzle can be prevented, thereby improving discharging stability.

The polyether-modified siloxane compound is at least one member selected from the group consisting of compounds represented by Chemical Formulae 1 to 4, which maintain dispersion stability, low dynamic surface tension, permeability, and leveling properties regardless of the type of coloring material or the combination of organic solvents.

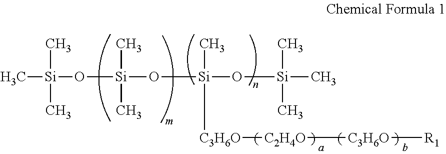

In the Chemical Formula 1, R₁ represents a hydrogen atom or an alkyl group having 1 to 4 carbon atoms, m represents 0 or an integer of from 1 to 23, n represents an integer of from 1 to 10, a represents an integer of from 1 to 23, and b represents 0 or an integer of from 1 to 23.

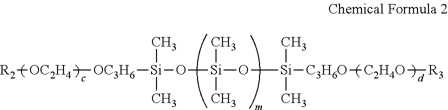

In the Chemical Formula 2, R₂ and R₃ each, independently represent hydrogen atoms or alkyl groups having 1 to 4 carbon atoms, m represents an integer of from 1 to 8, and c and d each, independently represent integers of from 1 to 10.

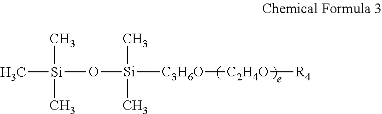

In the Chemical Formula 3, R₄ represents a hydrogen atom or an alkyl group having 1 to 4 carbon atoms and e represents an integer of 1 to 8.

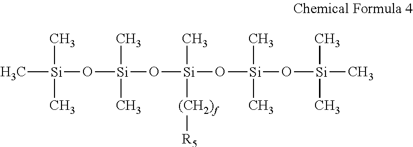

In the Chemical Formula 4, R₅ represents a polyether group represented by the following Formula 5 and f represents an integer of from 1 to 8.

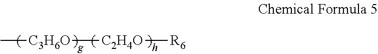

In the Chemical Formula 5, R₆ represents a hydrogen atom or an alkyl group having 1 to 4 carbon atoms, g represents 0 or an integer of from 1 to 23, and h represents 0 or an integer of from 1 to 23, excluding the case in which g and h are simultaneously 0.

The compound represented by Chemical Formula 1 includes, but are not limited to, the compound represented by the Chemical Structures (1) to (8) below.

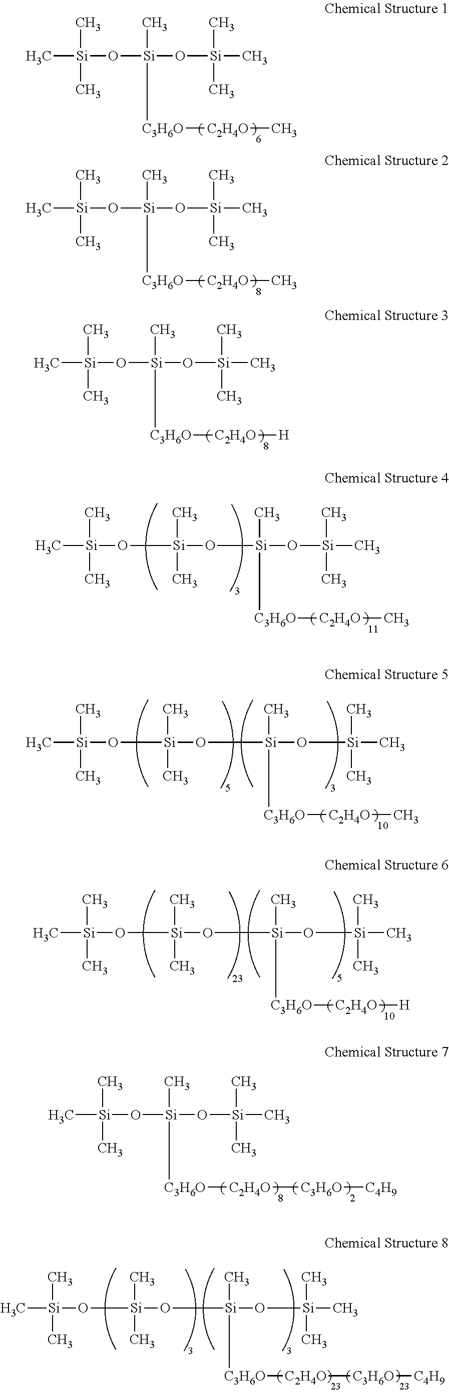

Specific compounds represented by Chemical Formula 2 includes, but are not limited to, the compound represented by the Chemical Structure (9) below.

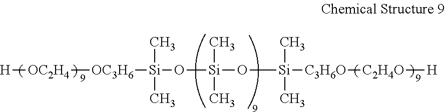

Specific compounds represented by Chemical Formula 3 includes, but are not limited to, the compound represented by the Chemical Structure (10) below.

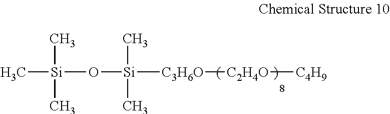

Specific compounds represented by Chemical Formula 4 includes, but are not limited to, the compound represented by the Chemical Structures 11 to 13 below.

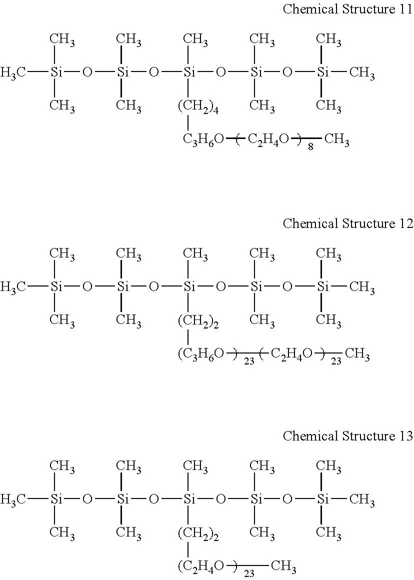

Any suitable synthetic polyether-modified siloxane compound and also commercially available products are usable.

The synthesis method of the polyether-modified siloxane compound has no particular limitation and can be suitably selected according to a particular application. Examples are shown in Japanese Patent Nos. 5101598, 5032325, and 5661229.

Specifically, the polyether-modified siloxane compound can be obtained by hydrosilylation reaction of (A) polyether and (B) organohydrogen siloxane.

The polyether as the component (A) represents polyoxyalkylene copolymers represented by the formula —(CₙH₂ₙO)—, where n represents an integer of from 2 to 4.

The polyoxyalikylene copolymer unit preferably includes oxyethylene unit —(C₂H₄O)—, oxypropylene unit —(C₃H₆O)—, oxybutylene unit —(C₄H₈O)—, or the mixture unit thereof. The oxyalkylene unit can be disposed in any manner and form a block or random copolymer structure. Of the two, the random copolymer structure is preferable. More preferably, polyoxyalikylene preferably includes both oxyethylene unit —(C₂H₄O)— and oxypropylene unit —(C₃H₆O)— in a random copolymer.

Organohydrogen siloxane as the component (B) includes organopolysiloxane including at least one hydrogen bonded with silicon (SiH) in one molecule. Examples of the organopolysiloxane are any arbitrary numbers or combinations of (R₃SiO_{0.5}), (R₂SiO), (RSiO_{1.5}), and (SiO₂), where R independently represents an organic group or a hydrocarbon group.

When R in (R₃SiO_{0.5}), (R₂SiO), and (RSiO_{1.5}) of the organopolysiloxane is a methyl group, the siloxy unit is represented as M, D, and T unit. (SiO₂) siloxy unit is represented as Q unit.

The organohydrogen siloxane has a similar structure and at least one SiH present on the siloxy unit.

The methyl-based siloxy unit in the organohydrogen siloxane include “MH” siloxy unit (R₂HSiO_{0.5}), “DE” siloxy unit (RHSiO), and “TH” siloxy unit (HSiO_{1.5}).

The organohydrogen siloxane may include any number of M, MH, D, DH, T, TH, or Q siloxy unit under the condition that at least one siloxy unit includes SiH.

The component (A) and the component (B) are caused to react in hydrosilylation reaction. There is no specific limitation on the hydrosilylation reaction and it can be suitably selected according to a particular application. Addition of a hydrosilylation catalyst is preferable to conduct the hydrosilylation reaction.

There is no specific limitation on the hydrosilylation catalyst and can be suitably selected according to a particular application. Specific examples include, but are not limited to, platinum, rhodium, ruthenium, palladium, osmium, or iridium metal, organic metal compounds thereof, and combinations thereof.

The content of the hydrosilylation catalyst is preferably from 0.1 to 1,000 ppm and more preferably from 1 to 100 ppm based on the mass of the component (A) and the component (B).

The hydrosililation reaction can be conducted without dilution or under the presence of a solvent. It is preferable under the presence of a solvent.

Specific examples of the solvent include, but are not limited to, alcohols (for example, methanol, ethanol, isopropanol, butanol, and n-propanol), ketones (for example, acetone, methylethyl ketone, and methyl isobutyl ketone), aromatic hydrocarbons (for example, benzene, toluene, and xylene), aliphatic hydrocarbons (for example, heptane, hexane, and octane), glycol ethers (for example, propylene glycol methylether, dipropylene glycol methylether, propylene glycol n-propylether, and ethylene glycol n-butyl ether), halogenized hydrocarbon (for example, dichloromethane, 1,1,1-trichloroethane, methylene chloride, and chloroform), dimethylsulfoxide, dimethyl fromamide, acetonitrile, tetrahydrofuran, benzine, mineral spirit, and naphtha.

These can be used alone or in combination.

The content of the component (A) and the component (B) for use in the hydrosilylation reaction has no particular limit and can be suitably adjusted according to a particular application. It is represented in the molar ratio of the content of all of the unsaturated groups in the component (A) and the content of SiH of the component (B). It is preferable to use an amount of at most 20 percent by mol polyether unsaturated groups to the SiH mol amount of organohydrogen siloxane. It is more preferable to use an amount of at most 10 percent by mol polyether unsaturated groups.

There is no specific limitation on the hydosilylation reaction and it can be conducted by any known batch method, semi-continuation method, or continuation method. For example, it is possible to conduct the reaction using a plug flow reactor.

Specific examples of polyether-modified siloxane compounds commercially available include, but are not limited to, 71ADDITIVE, 74ADDITIVE, 57ADDITIVE, 8029ADDITIVE, 8054ADDITIVE, 8211ADDITIVE, 8019ADDITIVE, 8526ADDITIVE, FZ-2123, and FZ-2191, all manufactured by Dow Corning Toray Co., Ltd., TSF4440, TSF4441, TSF4445, TSF4446, TSF4450, TSF4452, and TSF4460, all manufactured by Momentive Performance Materials Inc., SILFACE SAG002, SILFACE SAG003, SILFACE SAG005, SILFACE SAG503A, SILFACE SAG008, and SILFACE SJM003, all manufactured by Nisshin Chemical Co., Ltd., TEGO Wet KL245, TEGO Wet 250, TEGO Wet 260, TEGO Wet 265, TEGO Wet 270, and TEGO Wet 280, all manufactured by Evonik Industries AG, and BYK-345, BYK-347, BYK-348, BYK-375, and BYK-377, all manufactured by BYK Japan KK. These can be used alone or in combination.

Of these, TEGO Wet 270, manufactured by Evonik Industries AG and SILFACE SAG503A, manufactured by Nisshin Chemical Co., Ltd.) are preferable.

In addition to the polyether-modified siloxane compound, fluorochemical surfactants, silicone-based surfactants, acetylene glycol-based or acetylenealcohol-based surfactants can be used as the other surfactants in combination.

The proportion of the other surfactant based on the total amount of the ink is preferably from 0.001 to 5 percent by mass and more preferably from 0.5 to 3 percent by mass. A proportion of 0.001 to 5 percent by mass produces an ink minimally wet on the ink repelling film of the nozzle plate of an ink head. Therefore, the ink is prevented from adhering to the nozzle and being defectively discharged, thereby enhancing discharging stability.

### Water

As the water in the ink of the present disclosure, pure water and hyper pure water such as deionized water, ultrafiltered water, reverse osmosis water, and distilled water can be used.

The content of the water in the ink has no particular limit and can be selected according to a particular application.

### Other Components

Examples of the other components in the ink of the present disclosure are, but are not limited to, foam inhibitors (defoaming agents), water dispersible resins, pH regulators, preservatives and fungicides, chelate reagents, corrosion inhibitors, anti-oxidants, ultraviolet absorbers, oxygen absorbers, and photostabilizing agents.

### Foam Inhibitor (Defoaming Agent)

A minute amount of the foam inhibitor is added to ink to prevent foaming in the ink. The foaming means that liquid forms a thin film enclosing air. Forming foams is related to the properties of ink, such as surface tension and viscosity. That is, a force to make the surface area of liquid as least as possible is applied. Therefore, liquid such as water having a high surface tension never or little foams. Conversely, sticky ink with high permeability is likely to foam because it has low surface tension. The foam formed due to this high viscosity does not readily break but is maintained.

Normally, a foam inhibitor breaks foams by locally lowering the surface tension of foam film. Alternatively, a foam inhibitor insoluble in a foaming liquid breaks foams by dotting on the surface of the foaming liquid. When a polyether-modified siloxane compound having a very strong ability to reduce surface tension is used as a surfactant in the ink, a foam inhibitor operating by the former mechanism cannot locally reduce the surface tension of the foam film and is therefore generally not used. Consequently, a foam inhibitor that is insoluble in the foaming liquid is employed; however, in this case, insolubility of the foam inhibitor in the solution leads to deterioration of ink stability.

Conversely, although the foam inhibitor represented by the following Chemical Formula (a) is less able to reduce the surface tension than the polyether-modified siloxane compound, the compatibility with the polyether-modified siloxane compound is better. Thus, foam film is considered to take in the foam inhibitor efficiently and locally becomes unstable due to the difference in the surface tension between the inhibitor and a polyether-modified siloxane compound. Resultantly, the foam finally breaks.

As the foam inhibitor, a foam inhibitor containing the compound represented by the Chemical Formula 6 below is preferred.

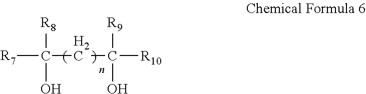

In the Chemical Formula (6), R₇ and R₈ each, independently represent alkyl groups having 3 to 6 carbon atoms, R₉ and R₁₀ each, independently represent alkyl groups having 1 or 2 carbon atoms, and n represents an integer of from 1 to 6.

Specific examples of the compound represented by Chemical Formula (a) include, but are not limited to, 2,4,7,9-tetramethyldecane-4,7-diol and 2,5,8,11-tetramethyl dodecane-5,8-diol. Of these, considering reduction effect on foam production and compatibility with ink, 2,5,8,11-tetramethyldodecane-5,8-diol is preferable.

The proportion of the foam inhibitor to the entire of ink is preferably from 0.01 to 10 percent by mass and more preferably from 0.1 to 5 percent by mass. When the proportion is at least 0.01 percent by mass, good defoaming property is obtained. When not greater than 10 percent by mass, good defoaming property is obtained so that ink properties such as viscosity and particle diameter become suitable.

### pH Regulator

As the pH regulator, any regulator capable of adjusting the pH to 7 to 11 without an adverse impact on prescribed ink is suitable.

Specific examples include, but are not limited to, alcohol amines, hydroxides of alkali metal elements, ammonium hydroxides, phosphonium hydoxides, and carbonates of alkali metal elements. A pH of less than 7 and greater than 11 increasingly dissolves an inkjet head and an ink supplying unit, leading to modification, leakage, low discharging performance of the ink.

Specific examples of the alcohol amines include, but are not limited to, diethanolamine, triethanolamine, and 2-amino-2-ethyl-1,3-propanediol.

Specific examples of the hydroxides of alkali metal elements include, but are not limited to, lithium hydroxide, sodium hydroxide, and potassium hydroxide.

Specific examples of the ammonium hydroxides include, but are not limited to, ammonium hydroxide and quaternary ammonium hydroxide.

One specific example of the phosphonium hydroxides is quaternary phosphonium hydroxide.

Specific examples of the alkali metal carbonates include, but are not limited to, lithium carbonate, sodium carbonate, and potassium carbonate.

### Preservatives and Fungicides

Specific examples of the preservatives and fungicides include, but are not limited to, dehydrosodium acetate, sodium sorbinate, sodium 2-pyridine thiol-1-oxide, sodium benzoate, and pentachlorophenol sodium.

### Chelate Reagent

Specific examples of the chelate reagents include, but are not limited to, ethylene diamine sodium tetraacetate, nitrilo sodium triacetate, hydroxyethylethylene diamine sodium tri-acetate, diethylenetriamine sodium quanternary acetate, and uramil sodium diacetate.

### Corrosion Inhibitor

Specific examples of the corrosion inhibitor include, but are not limited to, acid sulfite, thiosodium sulfate, antimony thioglycollate, diisopropyl ammonium nitrite, pentaerythritol tetranitrate, and dicyclohexyl ammonium nitrite.

### Anti-Oxidant

Specific examples of the anti-oxidants include, but are not limited to, phenol-based anti-oxidants (including hindered phenol-based anti-oxidants), amino-based anti-oxidants, sulfur-based anti-oxidants, and phosphorous-based anti-oxidants.

### Method of Manufacturing Ink

The ink of the present disclosure is prepared by dissolving or dispersing the coloring material, the organic solvent, the surfactant, the cation-based polyethylene wax, the other surfactant, and optional components in water, optionally followed by stirring and mixing. For stirring and mixing, devices such as a sand mill, a homogenizer, a ball mill, a paint shaker, an ultrasonic wave dispersing device, a stirrer having a stirring wing, a magnetic stirrer, and a high performance dispersing device are used.

### Ink Properties

Properties of the ink are not particularly limited and they can be suitably selected according to a particular application. The ink preferably has properties, such as viscosity, surface tension, and pH, in the following ranges.

Viscosity of the ink is preferably from 3 to 15 mPa·S at 25 degrees Celsius. More preferably, viscosity of the ink at 25 degrees Celsius is in the range of from 5 to 10 mPa·S. When the ink viscosity is at least 3 mPa·S, printing density and text quality are enhanced. When the ink viscosity is at most 15 mPa·S, the ink discharging property is suitably ensured.

The viscosity can be measured by a viscometer (RE-85L, manufactured by TOKI SANGYO CO., LTD.) at 25 degrees Celsius.

The ink of the present disclosure can be suitably used for inkjet recording or spray painting.

The ink for inkjet printing is used in any printer having an inkjet head such as a piezoelectric element type in which ink droplets are discharged by transforming a vibration plate forming the wall of the ink flowing path using a piezoelectric element as a pressure generating device to press the ink in the ink flowing path as described in Japanese Unexamined Patent Application Publication No. H2-51734; a thermal type in which bubbles are produced by heating ink in the ink flowing path with a heat element as described in Japanese Unexamined Patent Application Publication No. S61-59911; and an electrostatic type in which ink droplets are discharged by changes of the volume in the ink flowing path caused by transforming a vibration plate that forms the wall surface of the ink flowing path by a force of electrostatic generated between the vibration plate and the electrode while the vibration plate and the electrode are provided facing each other as described in Japanese Unexamined Patent Application Publication No. H6-71882.

### Ink Container

The ink container of the present disclosure includes ink accommodating unit to accommodate the ink of the present disclosure and other optional suitably-selected members.

There is no specific limitation on the ink container. It is possible to select any form, any structure, any size, and any material according to a particular application. For example, an ink container including an ink bag made of aluminum laminate film, plastic film, etc. Can be suitably used.

### Image Forming Method and Image Forming Apparatus

The image forming method of the present disclosure includes at least an ink discharging process and other optional processes on a necessity basis.

The image forming apparatus of the present disclosure includes at least an inkjetting device (ink discharging device) and other suitably selected optional devices on a necessity basis.

The image forming method of the present disclosure is executed by the image forming apparatus of the present disclosure and the ink discharging process is suitably conducted by the ink discharging device. In addition, the other processes are suitably conducted by the other corresponding devices.

### Ink Discharging Process and Ink Discharging Device

The ink discharging process includes applying a stimulus (energy) to the ink of the present disclosure to discharge (jet) the ink to form an image on a recording medium.

The ink discharging device applies a stimulus (energy) to the ink of the present disclosure to jet the ink to form an image on a recording medium. There is no specific limitation on the ink discharging device. For example, various nozzles for discharging ink can be suitably used.

The stimulus (energy) is generated by, for example, a stimulus generating device. There is no specific limitation on the selection of the stimuli. Heat (temperature), pressure, vibration, and light can be suitably selected. These can be used alone or in combination. Of these, heat and pressure are preferable.

Examples of the stimulus-generating device include, but are not limited to, a heating device, a pressurizing device, a piezoelectric element, a vibration generator, an ultrasonic oscillator, and a light source.

Specific examples include, but are not limited to, a piezoelectric actuator such as a piezoelectric element, a thermal actuator utilizing phase change by film boiling of liquid using an electrothermal conversion element such as a heating resistor, a shape-memory alloy actuator utilizing metal phase change caused by temperature variation, and an electrostatic actuator utilizing electrostatic force.

There is no specific limitation on how the ink is jetted (discharged), which differs depending on the type of the stimulus. For example, in a case in which the stimulus is “heat”, a method can be used in which thermal energy corresponding to recording signals is applied by, for example, a thermal head to produce foams in the ink and the ink is jetted and sprayed as liquid droplets from through orifices of nozzles of the recording head by the pressure of the foams. In addition, in a case in which the stimulus is “pressure”, a method can be used in which ink is discharged and sprayed from the nozzles of a print head as droplets by applying a voltage to a piezoelectric element attached to the position of a pressure chamber located in the ink flow path in the print head, thereby bending the piezoelectric element, resulting in a decrease in the volume of the pressure chamber.

### Other Processes and Other Devices

The other optional processes are not particularly limited and can be suitably selected according to a particular application. Examples are a drying process and a control process.

The other optional devices are not particularly limited and can be suitably selected according to a particular application. Examples are a drying device and a control device.

### Drying Process and Drying Device

The drying process is to heat and dry a recording medium on which an image is recorded with the ink. The drying process is executed by a drying device.

The drying is not particularly limited and can be suitably selected according to a particular application. For example, the drying can be conducted by an infrared drier, a microwave drier, a roll heater, a drum heater, or heated air. Moreover, it is also suitable to include a fixing process of heating the surface of an image to smooth the surface and fix the image with a heater to 100 to 150 degrees Celsius.

This fixing process improves gloss and fixability of recorded matter. A device such as a roller and a drum heater having a heated mirror surface is preferably used as the heating and fixing device and the mirror surface (smoothing portion) is brought into contact with the image formed surface. Taking into account image quality, safety, and economy, it is preferable to heat a fixing roller at 100 to 150 degrees Celsius.

### Control Process and Control Device

The control process mentioned above is to control each process and can be suitably conducted by the control device.

The controlling device (controller) is not particularly limited and can be suitably selected according to a particular application as long as it can control the behavior of each device. Specific examples include, but are not limited to, a sequencer and a computer.

The ink of the present disclosure can be suitably applied to various recording devices employing an inkjet recording method, such as printers, facsimile machines, photocopiers, multifunction peripherals (serving as a printer, a facsimile machine, and a photocopier), and solid freeform fabrication devices (3D printers, additive manufacturing devices).

In the present disclosure, the printing device (recording device) and the printing method (recording method) respectively represent a device capable of discharging ink and liquids such as processing fluids to a printing medium and a method of printing utilizing such a device. The recording (printing) medium refers to an item to which ink or processing fluids can be temporarily or permanently attached.

The recording (printing) device may furthermore optionally include a device relating to feeding, conveying, and ejecting a printing medium and other devices referred to as a pre-processing device and a post-processing device in addition to the head portion for discharging an ink.

The printing device and the printing method may further optionally include a heater for use in the heating process and a drier for use in the drying process. For example, the heating device and the drying device include devices including heating and drying the print surface of a printing medium and the opposite surface thereof. The heating device and the drying device are not particularly limited. For example, a fan heater and an infrared heater can be used. Heating and drying can be conducted before, in the middle of, or after printing.

In addition, the printing device and the printing method are not limited to those producing meaningful visible images such as text and figures with ink. Apparatuses and devices for creating patterns like geometric design and 3D images are included.

In addition, the printing device includes both a serial type device with a movable liquid discharging head and a line type device with a fixed liquid discharging head, unless otherwise specified.

Furthermore, in addition to the desktop type, this printing device includes a device capable of printing images on a wide printing medium having, for example, A0 size, and a continuous printer capable of using continuous paper rolled up in a roll-like form as a printing medium.

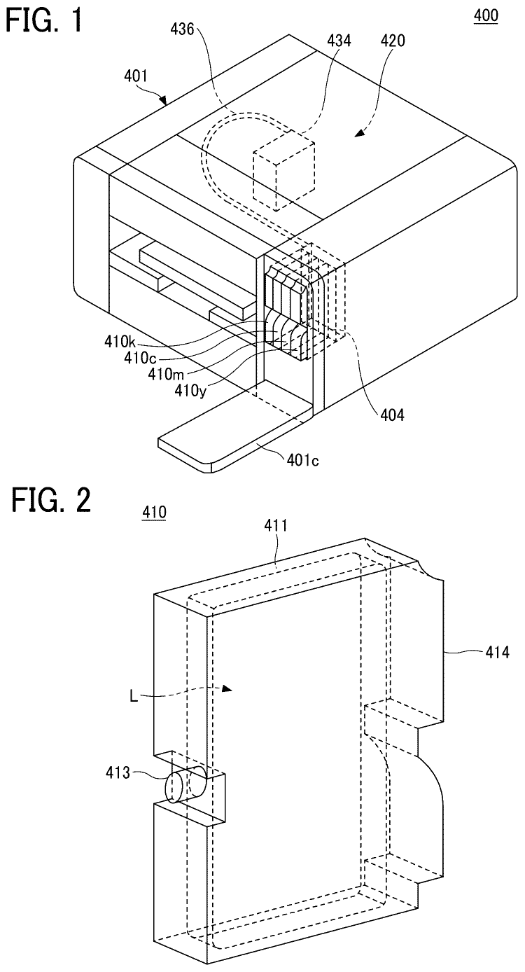

The recording (print) apparatus is described using an example with reference to FIG. 1 and FIG. 4. FIG. 1 is a diagram illustrating a perspective view of this apparatus. FIG. 2 is a diagram illustrating a perspective view of the tank of the apparatus. An image forming apparatus 400 as an embodiment of the printing apparatus is a serial image forming apparatus. The image forming apparatus 400 includes a mechanical unit 420 inside an exterior 401. Each ink accommodating unit (ink container) 411 of each tank 410 (410k, 410c, 410m, and 410y) for each color of black (K), cyan (C), magenta (M), and yellow (Y) is made of a packaging member such as aluminum laminate film. The ink accommodating unit 411 is housed in, for example, a plastic container housing unit 414 and L represents liquid contained in the ink accommodating unit 411. The tank 410 is used as an ink cartridge of each color.

A cartridge holder 404 is disposed on the rear side of the opening appearing when a cover 401c is opened. The tank 410 is detachably attached to the cartridge holder 404. This configuration enables each ink discharging outlet 413 of the tank 410 to communicate with a head (discharging head) 434 for each color via a supplying tube 436 for each color so that the ink can be discharged from the discharging head 434 to a printing medium.

This printing device may include not only a part for discharging ink but also a device referred to as a pre-processing device and a post-processing device.

As an example of the pre-processing device and the post-processing device, like the ink of black (K), cyan (C), magenta (M), and yellow (Y) ink, the pre-processing device and the post-processing device may further include a liquid accommodating unit including a pre-processing liquid or a post-processing liquid and a liquid discharging head to discharge the pre-processing liquid or the post-processing liquid according to an inkjet printing method.

Alternatively, the pre-processing device and the post-processing device possibly employ a blade coating method, a roll coating method, or a spray coating method other than the inkjet printing method.

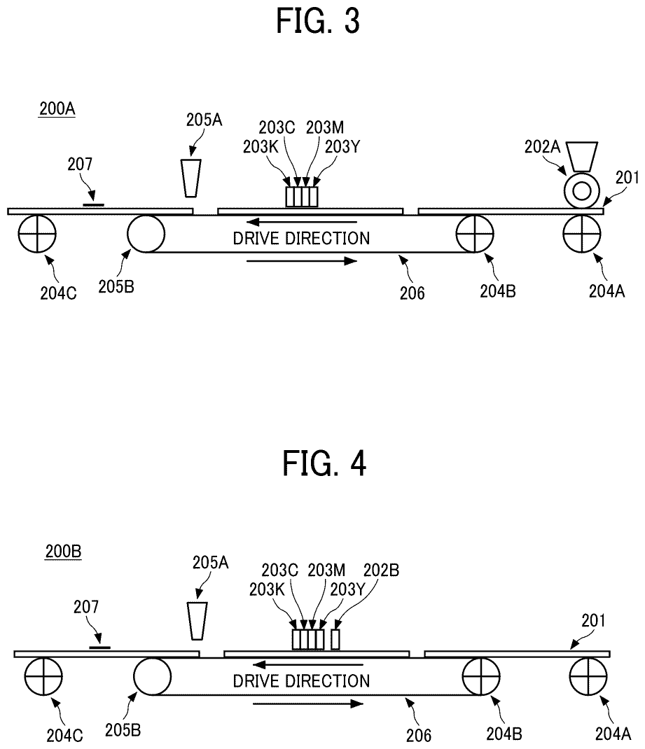

FIG. 3 is a diagram illustrating a cross sectional view of an example of a printing device using the ink of the present disclosure. As an example of a recording apparatus, an image forming apparatus 200A is provided with a pre-processing liquid applying unit 202A that applies a pre-processing liquid to a recording medium 201. The recording medium 201 is conveyed by a drive roller 204 (204A, 204B, 204C) and a conveyance belt 206, and ink is discharged from ink discharge heads 203 (203k, 203c, 203m, 203y) for each color of black (K), cyan (C), magenta (M), and yellow (Y) to the recording medium 201 to form an image 207. The image 207 is then dried by a drying unit (hot-air drying) 205A and a drying unit (heat roller) 205B.

FIG. 4 is a cross-sectional explanatory view illustrating another configuration of a recording apparatus using the ink according to the present invention. As an example of a recording apparatus, an image forming apparatus 200B is provided with a pre-processing liquid discharge head 202B that discharges a pre-processing liquid onto the recording medium 201. Except that the pre-processing liquid is applied by using the pre-processing liquid discharge head 202B instead of the pre-processing liquid applying unit 202A, image formation is performed in the same manner as in the image forming apparatus 200A illustrated in FIG. 3.

Notably, the ink is applicable not only to the inkjet printing but can be widely applied in other methods. Specific examples of such methods other than inkjetting include, but are not limited to, blade coating methods, gravure coating methods, bar coating methods, roll coating methods, dip coating methods, curtain coating methods, slide coating methods, die coating methods, and spray coating methods.

The usage of the ink of the present disclosure is not particularly limited and can be suitably selected according to a particular application. For example, the ink can be used for printed matter, a paint, a coating material, and foundation. The liquid compositions can be used as ink to produce text and images. They also can be used as a material for solid fabrication for manufacturing a three-dimensional image (or solid freeform fabrication object).

Any known device can be used as the device for manufacturing a solid freeform fabrication object without a particular limit. For example, a device including a container, supplying device, discharging device, drier of ink, and others can be used. The solid freeform fabrication object includes an object manufactured by repetitive coating of ink. In addition, the solid freeform fabrication object includes a mold-processed product manufactured by processing a structure having a substrate such as a printing medium to which the ink is applied. The mold-processed product is manufactured from printed matter or a structure having a sheet-like form and film-like form by, for example, heating drawing or punching. The mold-processed product is suitably used to produce items surface-decorated after molding such as gauges or operation panels of vehicles, office machines, electric and electronic devices, and cameras.

### Printing Medium

There is no specific limitation on the printing medium (recording medium) and it can be suitably selected according to a particular application. Printing media such as plain paper, gloss paper, special paper, cloth, film, transparent sheets, general printing paper are suitable.

The formed image has high quality without blurring and exhibits excellent long-term stability, making it suitable for various purposes such as reference materials on which text or images are recorded.

Among these, general printing paper having a liquid imbibition within a specific range is preferable for recording high-quality images with excellent image density, saturation, beading, color bleed, high gloss, and smear fixability. One specific example is a recording medium having a coated layer on at least one side thereof. The coated side preferably has a pure water transfer amount of 2 to 35 ml/m² at a contact time of 100 ms and 3 to 40 ml/m² at a contact time of 400 ms, as measured by a dynamic scanning absorptiometer (DSA).

General printing paper having a liquid imbibition in a particular range is available on the market.

Specific examples include, but are not limited to, POD gloss coat, OK TOP COAT+, OK KINFUJI+, and SA KINFUJI+ (manufactured by Oji Paper Co., Ltd.), SUPER MI DUL, AURORA COAT, and SPACE DX (manufactured by Nippon Paper Industries Co., Ltd.), a matte and u coat (manufactured by Hoketsu Paper Co., Ltd.), RAICHO ART and RAICHO SUPER ART (manufactured by Chuetsu Pulp & Paper Co., Ltd.), and PEARL COAT N (manufactured by Mitsubishi Paper Mills Limited).

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight rations in parts, unless otherwise specified.

### EXAMPLES

Next, the present disclosure is described in detail with reference to Examples but is not limited thereto.

### Preparation of Pigment Dispersion

### Preparation of Pigment Dispersion 1 (Surface Modified Black Pigment Dispersion)

A slurry was obtained by mixing 100 g of BLACK PEARLS® 1000 (carbon black with a BET specific surface area of 343 m²/g and a dibutyl phthalate absorption (DBPA) of 105 mL/100 g, available from Cabot Corporation), 100 mmol of sulfanilic acid (available from Hayashi Pure Chemical Ind., Ltd.), and 1 L of deionized highly pure water at room temperature (23 degrees Celsius±0.5 degrees Celsius) using a Silverson® mixer (laboratory mixer, available from Silverson Nippon Limited) at 6,000 rpm.

Next, 100 mmol of nitric acid (1.42, available from Honeywell-Fluka) was added to the obtained slurry. After an additional 30 minutes, 100 mmol of sodium nitrite (available from Hayashi Pure Chemical Ind., Ltd.) dissolved in 10 mL of deionized highly pure water was slowly added. The mixture was then heated to 60 degrees Celsius with stirring and reacted for 1 hour to obtain a modified pigment in which sulfanilic acid was added to the carbon black.

Subsequently, the pH was adjusted to 9 using a 10 percent tetrabutylammonium hydroxide methanol solution (available from FUJIFILM Wako Pure Chemical Corporation), and after 30 minutes, a modified pigment dispersion was obtained. Thereafter, ultrafiltration using a dialysis membrane was performed with the modified pigment dispersion and deionized highly pure water, followed by ultrasonic dispersion, to yield [Pigment Dispersion 1] containing 20 percent by mass of pigment solids.

The surface treatment level of the pigment in the obtained [Pigment Dispersion 1] was 0.75 mmol/g. Measurement with a nanotrac particle size distribution analyzer (NanoTrack II-UT151, available from MicrotracMRB Corp.) showed a cumulative 50 percent volume particle diameter (D50) of 120 nm.

### Preparation of Pigment Dispersion 2 (Surface Modified Magenta Pigment Dispersion)

A total of 1 kg of SMART Magenta 3122BA (C.I. Pigment Red 122 surface-treated dispersion, pigment solids content: 14.5 percent by mass, available from SENSIENT Technologies) was acid-precipitated using a 0.1 N aqueous hydrochloric acid solution (available from FUJIFILM Wako Pure Chemical Corporation).

Next, the pH was adjusted to 9 with a 10 percent aqueous tetraethylammonium hydroxide solution (also available from FUJIFILM Wako Pure Chemical Corporation), and after 30 minutes, a modified pigment dispersion containing a pigment bound to at least one aminobenzoic acid group or tetraethylammonium aminobenzoate was obtained.

Thereafter, ultrafiltration using a dialysis membrane was performed with the modified pigment dispersion and deionized highly pure water, followed by ultrasonic dispersion, to yield [Pigment Dispersion 2] containing 20 percent by mass of pigment solids.

[Pigment Dispersion 2] obtained was measured with a nanotrac particle size distribution analyzer (NanoTrack II-UT151, available from MicrotracMRB Corp.), and its cumulative 50 percent volume particle diameter (D50) was 104 nm.

### Preparation of Pigment Dispersion 3 (Surface Modified Cyan Pigment Dispersion)

A total of 1 kg of SMART Cyan 3154BA (C.I. Pigment Blue 15:4 surface-treated dispersion, pigment solids content: 14.5 percent by mass, available from SENSIENT Technologies) was acid-precipitated using a 0.1 N aqueous hydrochloric acid solution (available from FUJIFILM Wako Pure Chemical Corporation).

Next, the pH was adjusted to 9 with a 40 percent benzyltrimethylammonium hydroxide methanol solution (available from FUJIFILM Wako Pure Chemical Corporation), and after 30 minutes, a modified pigment dispersion containing a pigment bound to at least one aminobenzoic acid group or benzyltrimethylammonium aminobenzoate was obtained. Thereafter, ultrafiltration using a dialysis membrane was performed with the modified pigment dispersion and deionized highly pure water, followed by ultrasonic dispersion, to yield [Pigment Dispersion 3] containing 20 percent by mass of pigment solids.

[Pigment Dispersion 3] obtained was measured with a nanotrac particle size distribution analyzer (NanoTrack II-UT151, available from MicrotracMRB Corp.), and its cumulative 50 percent volume particle diameter (D50) was 116 nm.

### Preparation of Pigment Dispersion 4 (Surface Modified Yellow Pigment Dispersion)

A total of 1 kg of SMART Yellow 3074BA (C.I. Pigment Yellow 74 surface-treated dispersion, pigment solids content: 14.5 percent by mass, available from Sensient Technologies) was adjusted to pH 9 with a 10 percent by mass tetrabutylammonium hydroxide methanol solution (available from FUJIFILM Wako Pure Chemical Corporation), and after 30 minutes, a modified pigment dispersion containing a pigment bound to at least one aminobenzoic acid group or tetrabutylammonium aminobenzoate was obtained. Thereafter, ultrafiltration using a dialysis membrane was performed with the modified pigment dispersion and deionized highly pure water, followed by ultrasonic dispersion, to yield [Pigment Dispersion 4] containing 20 percent by mass pigment solids.

[Pigment Dispersion 4] obtained was measured with a nanotrac particle size distribution analyzer (NanoTrack II-UT151, available from MicrotracMRB Corp.), and its cumulative 50 percent volume particle diameter (D50) was 145 nm.

### Preparation of Pigment Dispersion 5 (Polymer Fine Particle Dispersion Containing Magenta Pigment)

The atmosphere in a 1 L flask equipped with a mechanical stirrer, thermometer, nitrogen gas inlet tube, reflux condenser, and dropping funnel was replaced with nitrogen gas. Then 11.2 g of styrene monomer (available from FUJIFILM Wako Pure Chemical Corporation), 2.8 g of acrylic acid (available from FUJIFILM Wako Pure Chemical Corporation), 12.0 g of lauryl methacrylate (available from BASF), 4.0 g of polyethylene glycol dimethacrylate (available from Sigma-Aldrich Japan), 4.0 g of styrene macromer (available from Toagosei Co., Ltd.), and 0.4 g of mercaptoethanol (available from FUJIFILM Wako Pure Chemical Corporation) were mixed in the flask and heated to 65 degrees Celsius. Next, a liquid mixture of 100.8 g of styrene, 25.2 g of acrylic acid, 108.0 g of lauryl methacrylate, 36.0 g of polyethylene glycol dimethacrylate, 60.0 g of hydroxyethyl methacrylate (available from Nippon Shokubai Co., Ltd.), 36.0 g of styrene macromer, 3.6 g of mercaptoethanol, 2.4 g of 2,2′-azobis(2,4-dimethylvaleronitrile) (95 percent, available from FUJIFILM Wako Pure Chemical Corporation), and 18 g of methyl ethyl ketone (available from FUJIFILM Wako Pure Chemical Corporation) was added dropwise to the flask over 2.5 hours.

After the dropwise addition, a liquid mixture of 0.8 g of 2,2′-azobis(2,4-dimethylvaleronitrile) (95 percent, available from FUJIFILM Wako Pure Chemical Corporation) and 18 g of methyl ethyl ketone was added dropwise to the flask over 0.5 hours. The mixture was stirred at 65 degrees Celsius for 1 hour, after which 0.8 g of 2,2′-azobis(2,4-dimethylvaleronitrile) was added and stirring was continued for another hour. After the reaction was complete, 364 g of methylethyl ketone was added to the flask to obtain 800 g of polymer solution A having a concentration of 50 percent by mass.

Next, 28 g of polymer solution A, 42 g of C.I. Pigment Red 122 (available from BASF), 13.6 g of a 1 mol/L aqueous potassium hydroxide solution (available from FUJIFILM Wako Pure Chemical Corporation), 20 g of methyl ethyl ketone, and 13.6 g of deionized water were stirred thoroughly and then kneaded using a roll mill. The resulting paste (approximately 117 g) was added to 200 g of pure water and stirred thoroughly, after which methyl ethyl ketone and water were distilled off using an evaporator. To remove coarse particles, the liquid dispersion was pressure-filtered through a polyvinylidene fluoride membrane filter with an average pore size of 5.0 μm (available from Sigma-Aldrich Japan), yielding [Pigment Dispersion 5] containing 15 percent by mass pigment solids and 20 percent by mass total solids.

[Pigment Dispersion 5] obtained was measured with a nanotrac particle size distribution analyzer (NanoTrack II-UT151, available from MicrotracMRB Corp.), and its cumulative 50 percent volume particle diameter (D50) was 127 nm.

### Preparation of Pigment Dispersion 6 (Polymer Fine Particle Dispersion Containing Cyan Pigment)

[Pigment Dispersion 6] containing 15 percent by mass pigment solids and 20 percent by mass total solids was prepared in the same manner as in Preparation of [Pigment Dispersion 5] except that C.I. Pigment Red 122 was changed to a phthalocyanine pigment (C.I. Pigment Blue 15:3, available from Dainichiseika Color & Chemicals Mfg. Co., Ltd.).

The polymer fine particle in the obtained [Pigment Dispersion 6] was measured with a particle size distribution measuring instrument (NANOTRAC UPA-EX150, available from NIKKISO CO., LTD.) and its cumulative average particle diameter D50 was 93 nm.

### Preparation of Pigment Dispersion 7 (Polymer Fine Particle Dispersion Containing Yellow Pigment)

[Pigment Dispersion 7] containing 15 percent by mass pigment solids and 20 percent by mass total solids was prepared in the same manner as in Preparation of [Pigment Dispersion 5] except that C.I. Pigment Red 122 was changed to a bisazo yellow pigment (C.I. Pigment Blue 155, available from DIC Corporation).

The polymer fine particle in the obtained [Pigment Dispersion 7] was measured with a nanotrac particle size distribution analyzer (NanoTrack II-UT151, available from MicrotracMRB Corp.), and its cumulative 50 percent volume particle diameter (D50) was 76 nm.

### Preparation of Pigment Dispersion 8 (Polymer Fine Particle Dispersion Containing Black Pigment)

[Pigment Dispersion 8] containing 15 percent by mass pigment solids and 20 percent by mass total solids was prepared in the same manner as in Preparation of [Pigment Dispersion 5] except that C.I. Pigment Red 122 was changed to carbon black (FW100, available from Degussa AG).

The polymer fine particle in the obtained [Pigment Dispersion 8] was measured with a nanotrac particle size distribution analyzer (NanoTrack II-UT151, available from MicrotracMRB Corp.), and its cumulative 50 percent volume particle diameter (D50) was 104 nm.

### Preparation of Cation-Based Polyethylene Wax Emulsion

### Preparation of Wax Emulsion 1

First, 150 g of polyethylene wax (Hi-WAX 4052E, manufactured by Mitsui Chemicals, Inc.) and 7.50 g of a cationic surfactant (SANISOL B-50, manufactured by Kao Corporation) were placed into a container of a pressure-type homogenizer LAB2000 (manufactured by SMT Co., Ltd.), followed by the addition of 342.5 g of highly pure water. The above mixture was heated to about 150 degrees Celsius to melt the polyethylene wax. Next, the aqueous mixture containing the molten wax was passed through the pressure-type homogenizer LAB2000 at a flow rate of about 150 mL/min for about 20 minutes by pump feeding, while fully opening the primary homogenizing valve and partially closing the secondary homogenizing valve so that the homogenizing pressure reached about 1,000 bar. Subsequently, the primary homogenizing valve was partially closed to increase the homogenizing pressure to about 1,500 bar. While maintaining the reactor mixture at about 150 degrees Celsius, the mixture was circulated through the homogenizer at a flow rate of about 150 mL/min for about 45 minutes. Thereafter, the homogenizer was stopped, and the reactor mixture was cooled from 150 degrees Celsius to 40 degrees Celsius over 45 minutes, transferred to another container, and filtered through a 5-micron polyester filter bag to obtain [Wax Emulsion 1].

### Preparation of Wax Emulsion 2

[Wax Emulsion 2] was prepared in the same manner as [Wax Emulsion 1] except that the polyethylene wax Hi-WAX 4052E was replaced with Hi-WAX 405MP (manufactured by Mitsui Chemicals, Inc.).

### Preparation of Wax Emulsion 3

[Wax Emulsion 3] was prepared in the same manner as [Wax Emulsion 1] except that the polyethylene wax Hi-WAX 4052E was replaced with Hi-WAX 400P (manufactured by Mitsui Chemicals, Inc.).

Each prepared wax emulsion was measured using a Nanotrac particle size analyzer (Nanotrac Wave II-UT151, manufactured by Microtrac MRB Co., Ltd.). Table 1 shows the wax solid content, wax melting point, and cumulative 50 percent volume particle diameter (D50) for Wax Emulsions 1 to 3.

TABLE 1

| | | Wax solids | Wax melting | |
|---|---|---|---|---|
| | Cation-based | content | point | |
| | polyethylene | (percent by | (degrees | Particle size |
| | wax | mass) | Celsius) | (D50) (nm) |
| Wax Emulsion 1 | Hi-WAX 4052E | 30 | 110 | 210 |
| Wax Emulsion 2 | Hi-WAX | 30 | 121 | 220 |
| | 405MP | | | |

### Preparation of Ink

### Preparation of Ink 1

A container equipped with a stirrer was charged with 20.00 parts by mass of ethylene glycol, 5.00 parts by mass of 1,2-hexanediol, 0.30 parts by mass of 2,5,8,11-tetramethyldodecane-5,8-diol, and 0.20 parts by mass of a surfactant (Capstone FS3100), and the mixture was stirred for 30 minutes to obtain a uniform composition. Next, 0.05 parts by mass of a preservative (Proxel GXL, manufactured by Avecia), 0.20 parts by mass of 2-amino-2-ethyl-1,3-propane-diol, 30.0 parts by mass of [Pigment Dispersion 1], and pure water in an amount sufficient to make the total 100 parts by mass including the resin components to be added later were added, and the mixture was stirred for 20 minutes to obtain a uniform ink. Further, 0.90 parts by mass (solid content: 0.52 parts by mass) of TOCRYL BCX-8111 (Tg: −30 degrees Celsius, solid content: 58 percent by mass), as the first resin, 20.0 parts by mass (solid content: 6.0 parts by mass) of TAKELAC W-6020 (Tg: 90 degrees Celsius, solid content: 30 percent by mass), as the second resin, and 1.67 parts by mass of [Wax Emulsion 1] were added, and the mixture was stirred for 30 minutes to obtain a uniform ink.

The resulting ink was pressure-filtered through a polyvinylidene fluoride membrane filter having an average pore size of 1.2 μm to remove coarse particles and debris, thereby preparing [Ink 1].

### Preparation of Inks 2 to 44

[Inks 2] to [Ink 44] were prepared in the same manner as Ink 1 except that the materials shown in Tables 2 to 7 were used in place of those used in the preparation of [Ink 1]. In Tables 2 to 7, the unit for the content of each material is “percent by mass”.

TABLE 2

| Material | | | | | |
|---|---|---|---|---|---|
| | | Active | | | |
| Classification | Material name | ingredient | Ink 1 | Ink 2 | Ink 3 |
| Coloring | Pigment Dispersion | 20.0 | 30.00 | — | — |
| material | 1 | percent | | | |
| | Pigment Dispersion | 20.0 | — | 30.00 | — |
| | 2 | percent | | | |
| | Pigment Dispersion | 20.0 | — | — | 25.00 |
| | 3 | percent | | | |
| | Pigment Dispersion | 20.0 | — | — | — |
| | 4 | percent | | | |
| | Pigment Dispersion | 15.0 | — | — | — |
| | 5 | percent | | | |
| | Pigment Dispersion | 15.0 | — | — | — |
| | 6 | percent | | | |
| | Pigment Dispersion | 15.0 | — | — | — |
| | 7 | percent | | | |
| | Pigment Dispersion | 15.0 | — | — | — |
| | 8 | percent | | | |
| First resin | SUPERFLEX 420 | 32.0 | — | — | — |
| | | percent | | | |
| | SUPERFLEX 460 | 38.0 | — | — | — |
| | | percent | | | |
| | SUPERFLEX 470 | 38.0 | — | — | — |
| | | percent | | | |
| | TOCRYL BCX-8111 | 58.0 | 0.90 | 0.90 | 1.72 |
| | | percent | | | |
| | TOCRYL W-168 | 49.5 | — | — | — |
| | | percent | | | |
| | Hiros-X JE-1113 | 41.7 | — | — | — |
| | | percent | | | |
| | Solids content of first resin | | 0.52 | 0.52 | 1.00 |
| Second resin | SUPERFLEX 170 | 33.0 | — | — | — |
| | | percent | | | |
| | TAKELAC W-5661 | 35.0 | — | — | — |
| | | percent | | | |
| | TAKELAC W-6020 | 30.0 | 20.00 | 20.00 | 23.33 |
| | | percent | | | |
| | Hiros-X JE-1056 | 43.5 | — | — | — |
| | | percent | | | |
| | Hiros-X KE-1062 | 42.6 | — | — | — |
| | | percent | | | |
| | TOCRYL W-3080 | 41.8 | — | — | — |
| | | percent | | | |
| | Solids content of second resin | | 6.00 | 6.00 | 7.00 |
| Organic | Glycerin | 100 | — | — | — |
| solvent | | percent | | | |
| | Ethylene glycol | 100 | 20.00 | 20.00 | 22.00 |
| | | percent | | | |
| | 3-methyl-1,3-butane | 100 | — | — | — |
| | diol | percent | | | |
| | 1,2-hexane diol | 100 | 5.00 | 5.00 | 5.00 |
| | | percent | | | |
| | 1,2-butanediol | 100 | — | — | — |
| | | percent | | | |
| | 2,3-Butane diol | 100 | — | — | — |
| | | percent | | | |
| | 1,2-propane diol | 100 | — | — | — |
| | | percent | | | |
| | 1-methoxy-2- | 100 | — | — | — |
| | propanol | percent | | | |
| | 1-ethoxy-2-propanol | 100 | — | — | — |
| | | percent | | | |
| | 1-propoxy-2- | 100 | — | — | — |
| | propanol | percent | | | |
| | 3-methoxy-1-butanol | 100 | — | — | — |
| | | percent | | | |
| | 3-methoxy-3- | 100 | — | — | — |
| | methyl-1-butanol | percent | | | |
| | Ethylene glycol | 100 | — | — | — |
| | monobutyl ether | percent | | | |
| | Ethylene glycol | 100 | — | — | — |
| | monobutyl ether | percent | | | |
| Cation-based | Wax Emulsion 1 | 30 percent | 1.67 | 1.67 | 1.67 |
| polyethylene | Wax Emulsion 2 | 30 percent | — | — | — |
| wax | Wax Emulsion 3 | 30 percent | — | — | — |
| | AQUACER 840 | 35 percent | — | — | — |
| Other wax | AQUACER 537 | 30 percent | — | — | — |
| | AQUACER 531 | 45 percent | — | — | — |
| | AQUACER 593 | 30 percent | — | — | — |
| Surfactant | TEGO Wet 270 | 100 | — | — | — |
| | | percent | | | |
| | SILFACE SAG503A | 100 | — | — | — |
| | | percent | | | |
| | Surfynol 465 | 100 | — | — | — |
| | | percent | | | |
| | Capstone FS3100 | 100 | 0.20 | 0.20 | 0.20 |
| | | percent | | | |
| Mildew- | Proxel GXL | 20 percent | 0.05 | 0.05 | 0.05 |
| proofing | | | | | |
| agent | | | | | |
| Foam | 2,4,7,9-tetramethyl | 100 | — | — | — |
| inhibitor | decane-4,7-diol | percent | | | |
| (defoaming | 2,5,8,11- | 100 | 0.30 | 0.30 | 0.30 |
| agent) | tetramethyldodecane-5,8-diol | percent | | | |
| pH regulator | 2-amino-2-ethyl-1,3- | 100 | 0.20 | 0.20 | 0.20 |
| | propane diol | percent | | | |

| | | | |
|---|---|---|---|
| Pure water | Balance | Balance | Balance |
| Total | 100 | 100 | 100 |

| Material | | | | | |
|---|---|---|---|---|---|
| | | Active | | | |
| Classification | Material name | ingredient | Ink 4 | Ink 5 | Ink 6 |
| Coloring | Pigment Dispersion | 20.0 | — | 25.00 | — |
| material | 1 | percent | | | |
| | Pigment Dispersion | 20.0 | — | — | 25.00 |
| | 2 | percent | | | |
| | Pigment Dispersion | 20.0 | — | — | — |
| | 3 | percent | | | |
| | Pigment Dispersion | 20.0 | 25.00 | — | — |
| | 4 | percent | | | |
| | Pigment Dispersion | 15.0 | — | — | — |
| | 5 | percent | | | |
| | Pigment Dispersion | 15.0 | — | — | — |
| | 6 | percent | | | |
| | Pigment Dispersion | 15.0 | — | — | — |
| | 7 | percent | | | |
| | Pigment Dispersion | 15.0 | — | — | — |
| | 8 | percent | | | |
| First resin | SUPERFLEX 420 | 32.0 | — | — | — |
| | | percent | | | |
| | SUPERFLEX 460 | 38.0 | — | — | — |
| | | percent | | | |
| | SUPERFLEX 470 | 38.0 | — | — | — |
| | | percent | | | |
| | TOCRYL BCX-8111 | 58.0 | 1.72 | — | — |
| | | percent | | | |
| | TOCRYL W-168 | 49.5 | — | 3.03 | 3.03 |
| | | percent | | | |
| | Hiros-X JE-1113 | 41.7 | — | — | — |
| | | percent | | | |
| | Solids content of first resin | | 1.00 | 1.50 | 1.50 |
| Second resin | SUPERFLEX 170 | 33.0 | — | 18.18 | 18.18 |
| | | percent | | | |
| | TAKELAC W-5661 | 35.0 | — | — | — |
| | | percent | | | |
| | TAKELAC W-6020 | 30.0 | 23.33 | — | — |
| | | percent | | | |
| | Hiros-X JE-1056 | 43.5 | — | — | — |
| | | percent | | | |
| | Hiros-X KE-1062 | 42.6 | — | — | — |
| | | percent | | | |
| | TOCRYL W-3080 | 41.8 | — | — | — |
| | | percent | | | |
| | Solids content of second resin | | 7.00 | 6.00 | 6.00 |
| Organic | Glycerin | 100 | — | 10.00 | 10.00 |
| solvent | | percent | | | |
| | Ethylene glycol | 100 | 22.00 | — | — |
| | | percent | | | |
| | 3-methyl-1,3-butane | 100 | — | 20.00 | 20.00 |
| | diol | percent | | | |
| | 1,2-hexane diol | 100 | 5.00 | — | — |
| | | percent | | | |
| | 1,2-butanediol | 100 | — | — | — |
| | | percent | | | |
| | 2,3-Butane diol | 100 | — | — | — |
| | | percent | | | |
| | 1,2-propane diol | 100 | — | — | — |
| | | percent | | | |
| | 1-methoxy-2- | 100 | — | — | — |
| | propanol | percent | | | |
| | 1-ethoxy-2-propanol | 100 | — | — | — |
| | | percent | | | |
| | 1-propoxy-2- | 100 | — | — | — |
| | propanol | percent | | | |
| | 3-methoxy-1-butanol | 100 | — | — | — |
| | | percent | | | |
| | 3-methoxy-3-methyl- | 100 | — | — | — |
| | 1-butanol | percent | | | |
| | Ethylene glycol | 100 | — | — | — |
| | monobutyl ether | percent | | | |
| | Ethylene glycol | 100 | — | — | — |
| | monobutyl ether | percent | | | |
| Cation-based | Wax Emulsion 1 | 30 | 1.67 | — | — |
| polyethylene | | percent | | | |
| wax | Wax Emulsion 2 | 30 | — | 1.67 | 1.67 |
| | | percent | | | |
| | Wax Emulsion 3 | 30 | — | — | — |
| | | percent | | | |
| | AQUACER 840 | 35 | — | — | — |
| | | percent | | | |
| Other wax | AQUACER 537 | 30 | — | — | — |
| | | percent | | | |
| | AQUACER 531 | 45 | — | — | — |
| | | percent | | | |
| | AQUACER 593 | 30 | — | — | — |
| | | percent | | | |
| Surfactant | TEGO Wet 270 | 100 | — | — | — |
| | | percent | | | |
| | SILFACE SAG503A | 100 | — | — | — |
| | | percent | | | |
| | Surfynol 465 | 100 | — | 0.50 | 0.50 |
| | | percent | | | |
| | Capstone FS3100 | 100 | 0.20 | — | — |
| | | percent | | | |
| Mildew- | Proxel GXL | 20 | 0.05 | 0.05 | 0.05 |
| proofing | | percent | | | |
| agent | | | | | |
| Foam | 2,4,7,9-tetramethyl | 100 | — | — | — |
| inhibitor | decane-4,7-diol | percent | | | |
| (defoaming | 2,5,8,11- | 100 | 0.30 | — | — |
| agent) | tetramethyldodecane- | percent | | | |
| | 5,8-diol | | | | |
| pH regulator | 2-amino-2-ethyl-1,3- | 100 | 0.20 | 0.20 | 0.20 |
| | propane diol | percent | | | |

| | | | |
|---|---|---|---|
| Pure water | Balance | Balance | Balance |
| Total | 100 | 100 | 100 |

| Material | | | | |
|---|---|---|---|---|
| | | Active | | |
| Classification | Material name | ingredient | Ink 7 | Ink 8 |
| Coloring | Pigment Dispersion | 20.0 | — | — |
| material | 1 | percent | | |
| | Pigment Dispersion | 20.0 | — | — |
| | 2 | percent | | |
| | Pigment Dispersion | 20.0 | 12.50 | — |
| | 3 | percent | | |
| | Pigment Dispersion | 20.0 | — | 12.50 |
| | 4 | percent | | |
| | Pigment Dispersion | 15.0 | — | — |
| | 5 | percent | | |
| | Pigment Dispersion | 15.0 | — | — |
| | 6 | percent | | |
| | Pigment Dispersion | 15.0 | — | — |
| | 7 | percent | | |
| | Pigment Dispersion | 15.0 | — | — |
| | 8 | percent | | |
| First resin | SUPERFLEX 420 | 32.0 | — | — |
| | | percent | | |
| | SUPERFLEX 460 | 38.0 | — | — |
| | | percent | | |
| | SUPERFLEX 470 | 38.0 | — | — |
| | | percent | | |
| | TOCRYL BCX-8111 | 58.0 | — | — |
| | | percent | | |
| | TOCRYL W-168 | 49.5 | 4.04 | 4.04 |
| | | percent | | |
| | Hiros-X JE-1113 | 41.7 | — | — |
| | | percent | | |

| | | |
|---|---|---|
| Solids content of first resin | 2.00 | 2.00 |

| | | | | |
|---|---|---|---|---|
| Second resin | SUPERFLEX 170 | 33.0 | 22.73 | 22.73 |
| | | percent | | |
| | TAKELAC W-5661 | 35.0 | — | — |
| | | percent | | |
| | TAKELAC W-6020 | 30.0 | — | — |
| | | percent | | |
| | Hiros-X JE-1056 | 43.5 | — | — |
| | | percent | | |
| | Hiros-X KE-1062 | 42.6 | — | — |
| | | percent | | |
| | TOCRYL W-3080 | 41.8 | — | — |
| | | percent | | |

| | | |
|---|---|---|
| Solids content of second resin | 7.50 | 7.50 |

| | | | | |
|---|---|---|---|---|
| Organic | Glycerin | 100 | 10.00 | 10.00 |
| solvent | | percent | | |
| | Ethylene glycol | 100 | — | — |
| | | percent | | |
| | 3-methyl-1,3-butane | 100 | 22.00 | 22.00 |
| | diol | percent | | |
| | 1,2-hexane diol | 100 | — | — |
| | | percent | | |
| | 1,2-butanediol | 100 | — | — |
| | | percent | | |
| | 2,3-Butane diol | 100 | — | — |
| | | percent | | |
| | 1,2-propane diol | 100 | — | — |
| | | percent | | |
| | 1-methoxy-2- | 100 | — | — |
| | propanol | percent | | |
| | 1-ethoxy-2-propanol | 100 | — | — |
| | | percent | | |
| | 1-propoxy-2- | 100 | — | — |
| | propanol | percent | | |
| | 3-methoxy-1-butanol | 100 | — | — |
| | | percent | | |
| | 3-methoxy-3-methyl- | 100 | — | — |
| | 1-butanol | percent | | |
| | Ethylene glycol | 100 | — | — |
| | monobutyl ether | percent | | |
| | Ethylene glycol | 100 | — | — |
| | monobutyl ether | percent | | |
| Cation-based | Wax Emulsion 1 | 30 | — | — |
| polyethylene | | percent | | |
| wax | Wax Emulsion 2 | 30 | 1.67 | 1.67 |
| | | percent | | |
| | Wax Emulsion 3 | 30 | — | — |
| | | percent | | |
| | AQUACER 840 | 35 | — | — |
| | | percent | | |
| Other wax | AQUACER 537 | 30 | — | — |
| | | percent | | |
| | AQUACER 531 | 45 | — | — |
| | | percent | | |
| | AQUACER 593 | 30 | — | — |
| | | percent | | |
| Surfactant | TEGO Wet 270 | 100 | — | — |
| | | percent | | |
| | SILFACE SAG503A | 100 | — | — |
| | | percent | | |
| | Surfynol 465 | 100 | 0.50 | 0.50 |
| | | percent | | |
| | Capstone FS3100 | 100 | — | — |
| | | percent | | |
| Mildew- | Proxel GXL | 20 | 0.05 | 0.05 |
| proofing | | percent | | |
| agent | | | | |
| Foam | 2,4,7,9-tetramethyl | 100 | — | — |
| inhibitor | decane-4,7-diol | percent | | |
| (defoaming | 2,5,8,11- | 100 | — | — |
| agent) | tetramethyldodecane- | percent | | |
| | 5,8-diol | | | |
| pH regulator | 2-amino-2-ethyl-1,3- | 100 | 0.20 | 0.20 |
| | propane diol | percent | | |

| | | |
|---|---|---|
| Pure water | Balance | Balance |
| Total | 100 | 100 |

TABLE 3

| Material | | | | | |
|---|---|---|---|---|---|
| | | Active | | | |
| Classification | Material name | ingredient | Ink 9 | Ink 10 | Ink 11 |
| Coloring | Pigment Dispersion 1 | 20.0 | — | — | — |
| material | | percent | | | |
| | Pigment Dispersion 2 | 20.0 | — | — | — |
| | | percent | | | |
| | Pigment Dispersion 3 | 20.0 | — | — | — |
| | | percent | | | |
| | Pigment Dispersion 4 | 20.0 | — | — | — |
| | | percent | | | |
| | Pigment Dispersion 5 | 15.0 | — | 33.33 | — |
| | | percent | | | |
| | Pigment Dispersion 6 | 15.0 | — | — | 20.00 |
| | | percent | | | |
| | Pigment Dispersion 7 | 15.0 | — | — | — |
| | | percent | | | |
| | Pigment Dispersion 8 | 15.0 | 33.33 | — | — |
| | | percent | | | |
| First resin | SUPERFLEX 420 | 32.0 | — | — | — |
| | | percent | | | |
| | SUPERFLEX 460 | 38.0 | 2.63 | 2.63 | 3.95 |
| | | percent | | | |
| | SUPERFLEX 470 | 38.0 | — | — | — |
| | | percent | | | |
| | TOCRYL BCX-8111 | 58.0 | — | — | — |
| | | percent | | | |
| | TOCRYL W-168 | 49.5 | — | — | — |
| | | percent | | | |
| | Hiros-X JE-1113 | 41.7 | — | — | — |
| | | percent | | | |
| | Solids content of first resin | | 1.00 | 1.00 | 1.50 |
| Second resin | SUPERFLEX 170 | 33.0 | — | — | — |
| | | percent | | | |
| | TAKELAC W-5661 | 35.0 | 22.86 | 22.86 | 28.57 |
| | | percent | | | |
| | TAKELAC W-6020 | 30.0 | — | — | — |
| | | percent | | | |
| | Hiros-X JE-1056 | 43.5 | — | — | — |
| | | percent | | | |
| | Hiros-X KE-1062 | 42.6 | — | — | — |
| | | percent | | | |
| | TOCRYL W-3080 | 41.8 | — | — | — |
| | | percent | | | |
| | Solids content of second resin | | 8.00 | 8.00 | 10.00 |
| Organic | Glycerin | 100 | — | — | — |
| solvent | | percent | | | |
| | Ethylene glycol | 100 | 5.00 | 5.00 | 5.00 |
| | | percent | | | |
| | 3-methyl-1,3-butane | 100 | — | — | — |
| | diol | percent | | | |
| | 1,2-hexane diol | 100 | 2.00 | 2.00 | 3.00 |
| | | percent | | | |
| | 1,2-butanediol | 100 | — | — | — |
| | | percent | | | |
| | 2,3-Butane diol | 100 | — | — | — |
| | | percent | | | |
| | 1,2-propane diol | 100 | 20.00 | 20.00 | 20.00 |
| | | percent | | | |
| | 1-methoxy-2- | 100 | — | — | — |
| | propanol | percent | | | |
| | 1-ethoxy-2-propanol | 100 | — | — | — |
| | | percent | | | |
| | 1-propoxy-2- | 100 | — | — | — |
| | propanol | percent | | | |
| | 3-methoxy-1-butanol | 100 | — | — | — |
| | | percent | | | |
| | 3-methoxy-3-methyl- | 100 | — | — | — |
| | 1-butanol | percent | | | |
| | Ethylene glycol | 100 | — | — | — |
| | monobutyl ether | percent | | | |
| | Ethylene glycol | 100 | — | — | — |
| | monobutyl ether | percent | | | |
| Cation-based | Wax Emulsion 1 | 30 | — | — | — |
| polyethylene | | percent | | | |
| wax | Wax Emulsion 2 | 30 | — | — | — |
| | | percent | | | |
| | Wax Emulsion 3 | 30 | 1.00 | 1.00 | 1.00 |
| | | percent | | | |
| | AQUACER 840 | 35 | — | — | — |
| | | percent | | | |
| Other wax | AQUACER 537 | 30 | — | — | — |
| | | percent | | | |
| | AQUACER 531 | 45 | — | — | — |
| | | percent | | | |
| | AQUACER 593 | 30 | — | — | — |
| | | percent | | | |
| Surfactant | TEGO Wet 270 | 100 | — | — | — |
| | | percent | | | |
| | SILFACE SAG503A | 100 | 0.50 | 0.50 | 0.50 |
| | | percent | | | |
| | Surfynol 465 | 100 | — | — | — |
| | | percent | | | |
| | Capstone FS3100 | 100 | — | — | — |
| | | percent | | | |
| Mildew- | Proxel GXL | 20 | 0.05 | 0.05 | 0.05 |
| proofing | | percent | | | |
| agent | | | | | |
| Foam | 2,4,7,9-tetramethyl | 100 | 0.20 | 0.20 | 0.20 |
| inhibitor | decane-4,7-diol | percent | | | |
| (defoaming | 2,5,8,11- | 100 | — | — | — |
| agent) | tetramethyldodecane- | percent | | | |
| | 5,8-diol | | | | |
| pH regulator | 2-amino-2-ethyl-1,3- | 100 | 0.30 | 0.30 | 0.30 |
| | propane diol | percent | | | |
| Pure water | | | Balance | Balance | Balance |
| Total | | | 100 | 100 | 100 |
| Material | | | | | |
| | | Active | | | |
| Classification | Material name | ingredient | Ink 12 | Ink 13 | Ink 14 |
| Coloring | Pigment Dispersion 1 | 20.0 | — | 25.00 | — |
| material | | percent | | | |
| | Pigment Dispersion 2 | 20.0 | — | — | 25.00 |
| | | percent | | | |
| | Pigment Dispersion 3 | 20.0 | — | — | — |
| | | percent | | | |
| | Pigment Dispersion 4 | 20.0 | — | — | — |
| | | percent | | | |
| | Pigment Dispersion 5 | 15.0 | — | — | — |
| | | percent | | | |
| | Pigment Dispersion 6 | 15.0 | — | — | — |
| | | percent | | | |
| | Pigment Dispersion 7 | 15.0 | 20.00 | — | — |
| | | percent | | | |
| | Pigment Dispersion 8 | 15.0 | — | — | — |
| | | percent | | | |
| First resin | SUPERFLEX 420 | 32.0 | — | — | — |
| | | percent | | | |
| | SUPERFLEX 460 | 38.0 | 3.95 | — | — |
| | | percent | | | |
| | SUPERFLEX 470 | 38.0 | — | — | — |
| | | percent | | | |
| | TOCRYL BCX-8111 | 58.0 | — | — | — |
| | | percent | | | |
| | TOCRYL W-168 | 49.5 | — | — | — |
| | | percent | | | |
| | Hiros-X JE-1113 | 41.7 | — | 4.80 | 4.80 |
| | | percent | | | |
| | Solids content of first resin | | 1.50 | 2.00 | 2.00 |
| Second resin | SUPERFLEX 170 | 33.0 | — | — | — |
| | | percent | | | |
| | TAKELAC W-5661 | 35.0 | 28.57 | — | — |
| | | percent | | | |
| | TAKELAC W-6020 | 30.0 | — | — | — |
| | | percent | | | |
| | Hiros-X JE-1056 | 43.5 | — | — | — |
| | | percent | | | |
| | Hiros-X KE-1062 | 42.6 | — | — | — |
| | | percent | | | |
| | TOCRYL W-3080 | 41.8 | — | 16.75 | 16.75 |
| | | percent | | | |
| | Solids content of second resin | | 10.00 | 7.00 | 7.00 |
| Organic | Glycerin | 100 | — | — | — |
| solvent | | percent | | | |
| | Ethylene glycol | 100 | 5.00 | — | — |
| | | percent | | | |
| | 3-methyl-1,3-butane | 100 | — | — | — |
| | diol | percent | | | |
| | 1,2-hexane diol | 100 | 3.00 | — | — |
| | | percent | | | |
| | 1,2-butanediol | 100 | — | — | — |
| | | percent | | | |
| | 2,3-Butane diol | 100 | — | 5.00 | 5.00 |
| | | percent | | | |
| | 1,2-propane diol | 100 | 20.00 | 10.00 | 10.00 |
| | | percent | | | |
| | 1-methoxy-2- | 100 | — | — | — |
| | propanol | percent | | | |
| | 1-ethoxy-2-propanol | 100 | — | 2.00 | 2.00 |
| | | percent | | | |
| | 1-propoxy-2- | 100 | — | 3.00 | 3.00 |
| | propanol | percent | | | |
| | 3-methoxy-1-butanol | 100 | — | — | — |
| | | percent | | | |
| | 3-methoxy-3-methyl- | 100 | — | — | — |
| | 1-butanol | percent | | | |
| | Ethylene glycol | 100 | — | — | — |
| | monobutyl ether | percent | | | |
| | Ethylene glycol | 100 | — | — | — |
| | monobutyl ether | percent | | | |
| Cation-based | Wax Emulsion 1 | 30 | — | — | — |
| polyethylene | | percent | | | |
| wax | Wax Emulsion 2 | 30 | — | 3.33 | 3.33 |
| | | percent | | | |
| | Wax Emulsion 3 | 30 | 1.00 | — | — |
| | | percent | | | |
| | AQUACER 840 | 35 | — | — | — |
| | | percent | | | |
| Other wax | AQUACER 537 | 30 | — | — | — |
| | | percent | | | |
| | AQUACER 531 | 45 | — | — | — |
| | | percent | | | |
| | AQUACER 593 | 30 | — | — | — |
| | | percent | | | |
| Surfactant | TEGO Wet 270 | 100 | — | 0.30 | 0.30 |
| | | percent | | | |
| | SILFACE SAG503A | 100 | 0.50 | — | — |
| | | percent | | | |
| | Surfynol 465 | 100 | — | — | — |
| | | percent | | | |
| | Capstone FS3100 | 100 | — | — | — |
| | | percent | | | |
| Mildew- | Proxel GXL | 20 | 0.05 | 0.05 | 0.05 |
| proofing | | percent | | | |
| agent | | | | | |
| Foam | 2,4,7,9-tetramethyl | 100 | 0.20 | — | — |
| inhibitor | decane-4,7-diol | percent | | | |
| (defoaming | 2,5,8,11- | 100 | — | 0.30 | 0.30 |
| agent) | tetramethyldodecane- | percent | | | |
| | 5,8-diol | | | | |
| pH regulator | 2-amino-2-ethyl-1,3- | 100 | 0.30 | 0.30 | 0.30 |
| | propane diol | percent | | | |

| | | | |
|---|---|---|---|
| Pure water | Balance | Balance | Balance |
| Total | 100 | 100 | 100 |

| Material | | | | |
|---|---|---|---|---|
| | | Active | | |
| Classification | Material name | ingredient | Ink 15 | Ink 16 |
| Coloring | Pigment Dispersion 1 | 20.0 | — | — |
| material | | percent | | |
| | Pigment Dispersion 2 | 20.0 | — | — |
| | | percent | | |
| | Pigment Dispersion 3 | 20.0 | 12.50 | — |
| | | percent | | |
| | Pigment Dispersion 4 | 20.0 | — | 12.50 |
| | | percent | | |
| | Pigment Dispersion 5 | 15.0 | — | — |
| | | percent | | |
| | Pigment Dispersion 6 | 15.0 | — | — |
| | | percent | | |
| | Pigment Dispersion 7 | 15.0 | — | — |
| | | percent | | |
| | Pigment Dispersion 8 | 15.0 | — | — |
| | | percent | | |
| First resin | SUPERFLEX 420 | 32.0 | — | — |
| | | percent | | |
| | SUPERFLEX 460 | 38.0 | — | — |
| | | percent | | |
| | SUPERFLEX 470 | 38.0 | — | — |
| | | percent | | |
| | TOCRYL BCX-8111 | 58.0 | — | — |
| | | percent | | |
| | TOCRYL W-168 | 49.5 | — | — |
| | | percent | | |
| | Hiros-X JE-1113 | 41.7 | 6.59 | 6.59 |
| | | percent | | |

| | | |
|---|---|---|
| Solids content of first resin | 2.75 | 2.75 |

| | | | | |
|---|---|---|---|---|
| Second resin | SUPERFLEX 170 | 33.0 | — | — |
| | | percent | | |
| | TAKELAC W-5661 | 35.0 | — | — |
| | | percent | | |
| | TAKELAC W-6020 | 30.0 | — | — |
| | | percent | | |
| | Hiros-X JE-1056 | 43.5 | — | — |
| | | percent | | |
| | Hiros-X KE-1062 | 42.6 | — | — |
| | | percent | | |
| | TOCRYL W-3080 | 41.8 | 20.93 | 20.93 |
| | | percent | | |

| | | |
|---|---|---|
| Solids content of second resin | 8.75 | 8.75 |

| | | | | |
|---|---|---|---|---|
| Organic | Glycerin | 100 | — | — |
| solvent | | percent | | |
| | Ethylene glycol | 100 | — | — |
| | | percent | | |
| | 3-methyl-1,3-butane | 100 | — | — |
| | diol | percent | | |
| | 1,2-hexane diol | 100 | — | — |
| | | percent | | |
| | 1,2-butanediol | 100 | — | — |
| | | percent | | |
| | 2,3-Butane diol | 100 | 5.00 | 5.00 |
| | | percent | | |
| | 1,2-propane diol | 100 | 10.00 | 10.00 |
| | | percent | | |
| | 1-methoxy-2-propanol | 100 | — | — |
| | | percent | | |
| | 1-ethoxy-2-propanol | 100 | 2.00 | 2.00 |
| | | percent | | |
| | 1-propoxy-2-propanol | 100 | 3.00 | 3.00 |
| | | percent | | |
| | 3-methoxy-1-butanol | 100 | — | — |
| | | percent | | |
| | 3-methoxy-3-methyl- | 100 | — | — |
| | 1-butanol | percent | | |
| | Ethylene glycol | 100 | — | — |
| | monobutyl ether | percent | | |
| | Ethylene glycol | 100 | — | — |
| | monobutyl ether | percent | | |
| Cation-based | Wax Emulsion 1 | 30 percent | — | — |
| polyethylene | Wax Emulsion 2 | 30 percent | 3.33 | 3.33 |
| wax | Wax Emulsion 3 | 30 percent | — | — |
| | AQUACER 840 | 35 percent | — | — |
| Other wax | AQUACER 537 | 30 percent | — | — |
| | AQUACER 531 | 45 percent | — | — |
| | AQUACER 593 | 30 percent | — | — |
| Surfactant | TEGO Wet 270 | 100 | 0.30 | 0.30 |
| | | percent | | |
| | SILFACE SAG503A | 100 | — | — |
| | | percent | | |
| | Surfynol 465 | 100 | — | — |
| | | percent | | |
| | Capstone FS3100 | 100 | — | — |
| | | percent | | |
| Mildew- | Proxel GXL | 20 percent | 0.05 | 0.05 |
| proofing | | | | |
| agent | | | | |
| Foam | 2,4,7,9-tetramethyl | 100 | — | — |
| inhibitor | decane-4,7-diol | percent | | |
| (defoaming | 2,5,8,11- | 100 | 0.30 | 0.30 |
| agent) | tetramethyldodecane- | percent | | |
| | 5,8-diol | | | |
| pH regulator | 2-amino-2-ethyl-1,3- | 100 | 0.30 | 0.30 |
| | propane diol | percent | | |

| | | |
|---|---|---|
| Pure water | Balance | Balance |
| Total | 100 | 100 |

TABLE 4

| Material | | | | | |
|---|---|---|---|---|---|
| | | Active | | | |
| Classification | Material name | ingredient | Ink 17 | Ink 18 | Ink 19 |
| Coloring | Pigment dispersion 1 | 20.0 | — | — | — |
| material | | percent | | | |
| | Pigment dispersion 2 | 20.0 | — | — | — |
| | | percent | | | |
| | Pigment dispersion 3 | 20.0 | — | — | — |
| | | percent | | | |
| | Pigment dispersion 4 | 20.0 | — | — | — |
| | | percent | | | |
| | Pigment dispersion 5 | 15.0 | — | 26.67 | — |
| | | percent | | | |
| | Pigment dispersion 6 | 15.0 | — | — | 13.33 |
| | | percent | | | |
| | Pigment dispersion 7 | 15.0 | — | — | — |
| | | percent | | | |
| | Pigment dispersion 8 | 15.0 | 26.67 | — | — |
| | | percent | | | |
| First resin | SUPERFLEX 420 | 32.0 | 1.88 | 1.88 | — |
| | | percent | | | |
| | SUPERFLEX 460 | 38.0 | — | — | 2.63 |
| | | percent | | | |
| | SUPERFLEX 470 | 38.0 | — | — | — |
| | | percent | | | |
| | TOCRYL BCX-8111 | 58.0 | — | — | — |
| | | percent | | | |
| | TOCRYL W-168 | 49.5 | — | — | — |
| | | percent | | | |
| | Hiros-X JE-1113 | 41.7 | — | — | — |
| | | percent | | | |
| | Solids content of first resin | | 0.60 | 0.60 | 1.00 |
| Second resin | SUPERFLEX 170 | 33.0 | — | — | — |
| | | percent | | | |
| | TAKELAC W-5661 | 35.0 | — | — | — |
| | | percent | | | |
| | TAKELAC W-6020 | 30.0 | — | — | — |
| | | percent | | | |
| | Hiros-X JE-1056 | 43.5 | 18.39 | 18.39 | 25.29 |
| | | percent | | | |
| | Hiros-X KE-1062 | 42.6 | — | — | — |
| | | percent | | | |
| | TOCRYL W-3080 | 41.8 | — | — | — |
| | | percent | | | |
| | Solids content of second resin | | 8.00 | 8.00 | 11.00 |
| Organic | Glycerin | 100 | — | — | — |
| solvent | | percent | | | |
| | Ethylene glycol | 100 | — | — | — |
| | | percent | | | |
| | 3-methyl-1,3-butane | 100 | — | — | — |
| | diol | percent | | | |
| | 1,2-hexane diol | 100 | — | — | — |
| | | percent | | | |
| | 1,2-butanediol | 100 | 5.00 | 5.00 | 5.00 |
| | | percent | | | |
| | 2,3-butanediol | 100 | — | — | — |
| | | percent | | | |
| | 1,2-propane diol | 100 | 10.00 | 10.00 | 10.00 |
| | | percent | | | |
| | 1-methoxy-2-propanol | 100 | — | — | 1.00 |
| | | percent | | | |
| | 1-ethoxy-2-propanol | 100 | — | — | — |
| | | percent | | | |
| | 1-propoxy-2-propanol | 100 | — | — | — |
| | | percent | | | |
| | 3-methoxy-1-butanol | 100 | — | — | — |
| | | percent | | | |
| | 3-methoxy-3-methyl- | 100 | 5.00 | 5.00 | 5.00 |
| | 1-butanol | percent | | | |
| | Ethylene glycol | 100 | — | — | — |
| | monobutyl ether | percent | | | |
| | Ethylene glycol | 100 | 2.00 | 2.00 | 3.00 |
| | monobutyl ether | percent | | | |
| Cation-based | Wax Emulsion 1 | 30 | — | — | — |
| polyethylene | | percent | | | |
| wax | Wax Emulsion 2 | 30 | — | — | — |
| | | percent | | | |
| | Wax Emulsion 3 | 30 | — | — | — |
| | | percent | | | |
| | AQUACER 840 | 35 | 2.86 | 2.86 | 2.14 |
| | | percent | | | |
| Other wax | AQUACER 537 | 30 | — | — | — |
| | | percent | | | |
| | AQUACER 531 | 45 | — | — | — |
| | | percent | | | |
| | AQUACER 593 | 30 | — | — | — |
| | | percent | | | |
| Surfactant | TEGO Wet 270 | 100 | 0.10 | 0.10 | 0.10 |
| | | percent | | | |
| | SILFACE SAG503A | 100 | 0.50 | 0.50 | 0.50 |
| | | percent | | | |
| | Surfynol 465 | 100 | — | — | — |
| | | percent | | | |
| | Capstone FS3100 | 100 | — | — | — |
| | | percent | | | |
| Mildew- | Proxel GXL | 20 | 0.05 | 0.05 | 0.05 |
| proofing | | percent | | | |
| agent | | | | | |
| Foam | 2,4,7,9-tetramethyl | 100 | — | — | 0.30 |
| inhibitor | decane-4,7-diol | percent | | | |
| (defoaming | 2,5,8,11- | 100 | 0.20 | 0.20 | — |
| agent) | tetramethyldodecane- | percent | | | |
| | 5,8-diol | | | | |
| pH regulator | 2-amino-2-ethyl-1,3- | 100 | 0.30 | 0.30 | 0.30 |
| | propane diol | percent | | | |
| Pure water | | | Balance | Balance | Balance |
| Total | | | 100 | 100 | 100 |
| Material | | | | | |
| | | Active | | | |
| Classification | Material name | ingredient | Ink 20 | Ink 21 | Ink 22 |
| Coloring | Pigment dispersion 1 | 20.0 | — | — | — |
| material | | percent | | | |
| | Pigment dispersion 2 | 20.0 | — | — | — |
| | | percent | | | |
| | Pigment dispersion 3 | 20.0 | — | — | — |
| | | percent | | | |
| | Pigment dispersion 4 | 20.0 | — | — | — |
| | | percent | | | |
| | Pigment dispersion 5 | 15.0 | — | — | 33.33 |
| | | percent | | | |
| | Pigment dispersion 6 | 15.0 | — | — | — |
| | | percent | | | |
| | Pigment dispersion 7 | 15.0 | 13.33 | — | — |
| | | percent | | | |
| | Pigment dispersion 8 | 15.0 | — | 33.33 | — |
| | | percent | | | |
| First resin | SUPERFLEX 420 | 32.0 | — | — | — |
| | | percent | | | |
| | SUPERFLEX 460 | 38.0 | 3.95 | — | — |
| | | percent | | | |
| | SUPERFLEX 470 | 38.0 | — | 1.58 | 1.58 |
| | | percent | | | |
| | TOCRYL BCX-8111 | 58.0 | — | — | — |
| | | percent | | | |
| | TOCRYL W-168 | 49.5 | — | — | — |
| | | percent | | | |
| | Hiros-X JE-1113 | 41.7 | — | — | — |
| | | percent | | | |
| | Solids content of first resin | | 1.50 | 0.60 | 0.60 |
| Second resin | SUPERFLEX 170 | 33.0 | — | — | — |
| | | percent | | | |
| | TAKELAC W-5661 | 35.0 | — | — | — |
| | | percent | | | |
| | TAKELAC W-6020 | 30.0 | — | — | — |
| | | percent | | | |
| | Hiros-X JE-1056 | 43.5 | 25.29 | — | — |
| | | percent | | | |
| | Hiros-X KE-1062 | 42.6 | — | 14.08 | 14.08 |
| | | percent | | | |
| | TOCRYL W-3080 | 41.8 | — | 1.20 | 1.20 |
| | | percent | | | |
| | Solids content of second resin | | 11.00 | 6.50 | 6.50 |
| Organic | Glycerin | 100 | — | — | — |
| solvent | | percent | | | |
| | Ethylene glycol | 100 | — | 5.00 | 5.00 |
| | | percent | | | |
| | 3-methyl-1,3-butane | 100 | — | — | — |
| | diol | percent | | | |
| | 1,2-hexane diol | 100 | — | — | — |
| | | percent | | | |
| | 1,2-butanediol | 100 | 5.00 | — | — |
| | | percent | | | |
| | 2,3-butanediol | 100 | — | — | — |
| | | percent | | | |
| | 1,2-propane diol | 100 | 10.00 | 10.00 | 10.00 |
| | | percent | | | |
| | 1-methoxy-2-propanol | 100 | — | 2.00 | 2.00 |
| | | percent | | | |
| | 1-ethoxy-2-propanol | 100 | — | — | — |
| | | percent | | | |
| | 1-propoxy-2-propanol | 100 | — | — | — |
| | | percent | | | |
| | 3-methoxy-1-butanol | 100 | — | 5.00 | 5.00 |
| | | percent | | | |
| | 3-methoxy-3-methyl- | 100 | 5.00 | — | — |
| | 1-butanol | percent | | | |
| | Ethylene glycol | 100 | — | 1.00 | 1.00 |
| | monobutyl ether | percent | | | |
| | Ethylene glycol | 100 | 3.00 | — | — |
| | monobutyl ether | percent | | | |
| Cation-based | Wax Emulsion 1 | 30 | — | — | — |
| polyethylene | | percent | | | |
| wax | Wax Emulsion 2 | 30 | — | — | — |
| | | percent | | | |
| | Wax Emulsion 3 | 30 | — | 3.33 | 3.33 |
| | | percent | | | |
| | AQUACER 840 | 35 | 2.14 | — | — |
| | | percent | | | |
| Other wax | AQUACER 537 | 30 | — | — | — |
| | | percent | | | |
| | AQUACER 531 | 45 | — | — | — |
| | | percent | | | |
| | AQUACER 593 | 30 | — | — | — |
| | | percent | | | |
| Surfactant | TEGO Wet 270 | 100 | 0.10 | — | — |
| | | percent | | | |
| | SILFACE SAG503A | 100 | 0.50 | — | — |
| | | percent | | | |
| | Surfynol 465 | 100 | — | 1.0 | 1.0 |
| | | percent | | | |
| | Capstone FS3100 | 100 | — | — | — |
| | | percent | | | |
| Mildew- | Proxel GXL | 20 | 0.05 | 0.05 | 0.05 |
| proofing | | percent | | | |
| agent | | | | | |
| Foam | 2,4,7,9-tetramethyl | 100 | 0.30 | — | — |
| inhibitor | decane-4,7-diol | percent | | | |
| (defoaming | 2,5,8,11- | 100 | — | 0.10 | 0.10 |
| agent) | tetramethyldodecane- | percent | | | |
| | 5,8-diol | | | | |
| pH regulator | 2-amino-2-ethyl-1,3- | 100 | 0.30 | 0.20 | 0.20 |
| | propane diol | percent | | | |

| | | | |
|---|---|---|---|
| Pure water | Balance | Balance | Balance |
| Total | 100 | 100 | 100 |

| Material | | | | |
|---|---|---|---|---|
| | | Active | | |
| Classification | Material name | ingredient | Ink 23 | Ink 24 |
| Coloring | Pigment dispersion 1 | 20.0 | — | — |
| material | | percent | | |
| | Pigment dispersion 2 | 20.0 | — | — |
| | | percent | | |
| | Pigment dispersion 3 | 20.0 | — | — |
| | | percent | | |
| | Pigment dispersion 4 | 20.0 | — | — |
| | | percent | | |
| | Pigment dispersion 5 | 15.0 | — | — |
| | | percent | | |
| | Pigment dispersion 6 | 15.0 | 13.33 | — |
| | | percent | | |
| | Pigment dispersion 7 | 15.0 | | 20.00 |
| | | percent | | |
| | Pigment dispersion 8 | 15.0 | — | — |
| | | percent | | |
| First resin | SUPERFLEX 420 | 32.0 | — | — |
| | | percent | | |
| | SUPERFLEX 460 | 38.0 | — | — |
| | | percent | | |
| | SUPERFLEX 470 | 38.0 | 2.63 | 2.63 |
| | | percent | | |
| | TOCRYL BCX-8111 | 58.0 | — | — |
| | | percent | | |
| | TOCRYL W-168 | 49.5 | — | — |
| | | percent | | |
| | Hiros-X JE-1113 | 41.7 | — | — |
| | | percent | | |

| | | |
|---|---|---|
| Solids content of first resin | 1.00 | 1.00 |

| | | | | |
|---|---|---|---|---|
| Second resin | SUPERFLEX 170 | 33.0 | — | — |
| | | percent | | |
| | TAKELAC W-5661 | 35.0 | — | — |
| | | percent | | |
| | TAKELAC W-6020 | 30.0 | — | — |
| | | percent | | |
| | Hiros-X JE-1056 | 43.5 | — | — |
| | | percent | | |
| | Hiros-X KE-1062 | 42.6 | 18.78 | 18.78 |
| | | percent | | |
| | TOCRYL W-3080 | 41.8 | 1.20 | 1.20 |
| | | percent | | |

| | | |
|---|---|---|
| Solids content of second resin | 8.50 | 8.50 |

| | | | | |
|---|---|---|---|---|
| Organic | Glycerin | 100 | — | — |
| solvent | | percent | | |
| | Ethylene glycol | 100 | 5.00 | 5.00 |
| | | percent | | |
| | 3-methyl-1,3-butane | 100 | 2.00 | — |
| | diol | percent | | |
| | 1,2-hexane diol | 100 | — | — |
| | | percent | | |
| | 1,2-butanediol | 100 | — | — |
| | | percent | | |
| | 2,3-butanediol | 100 | — | — |
| | | percent | | |
| | 1,2-propane diol | 100 | 10.00 | 10.00 |
| | | percent | | |
| | 1-methoxy-2-propanol | 100 | 2.00 | 2.00 |
| | | percent | | |
| | 1-ethoxy-2-propanol | 100 | — | — |
| | | percent | | |
| | 1-propoxy-2-propanol | 100 | — | — |
| | | percent | | |
| | 3-methoxy-1-butanol | 100 | 5.00 | 5.00 |
| | | percent | | |
| | 3-methoxy-3-methyl- | 100 | — | — |
| | 1-butanol | percent | | |
| | Ethylene glycol | 100 | 1.00 | 1.00 |
| | monobutyl ether | percent | | |
| | Ethylene glycol | 100 | — | — |
| | monobutyl ether | percent | | |
| Cation-based | Wax Emulsion 1 | 30 | — | — |
| polyethylene | | percent | | |
| wax | Wax Emulsion 2 | 30 | — | — |
| | | percent | | |
| | Wax Emulsion 3 | 30 | 3.33 | 3.33 |
| | | percent | | |
| | AQUACER 840 | 35 | — | — |
| | | percent | | |
| Other wax | AQUACER 537 | 30 | — | — |
| | | percent | | |
| | AQUACER 531 | 45 | — | — |
| | | percent | | |
| | AQUACER 593 | 30 | — | — |
| | | percent | | |
| Surfactant | TEGO Wet 270 | 100 | — | — |
| | | percent | | |
| | SILFACE SAG503A | 100 | — | — |
| | | percent | | |
| | Surfynol 465 | 100 | 1.0 | 1.0 |
| | | percent | | |
| | Capstone FS3100 | 100 | — | — |
| | | percent | | |
| Mildew- | Proxel GXL | 20 | 0.05 | 0.05 |
| proofing | | percent | | |
| agent | | | | |
| Foam | 2,4,7,9-tetramethyl | 100 | — | — |
| inhibitor | decane-4,7-diol | percent | | |
| (defoaming | 2,5,8,11- | 100 | 0.10 | 0.10 |
| agent) | tetramethyldodecane- | percent | | |
| | 5,8-diol | | | |
| pH regulator | 2-amino-2-ethyl-1,3- | 100 | 0.20 | 0.20 |
| | propane diol | percent | | |

| | | |
|---|---|---|
| Pure water | Balance | Balance |
| Total | 100 | 100 |

TABLE 5

| Material | | | | | |
|---|---|---|---|---|---|
| | | Active | | | |
| Classification | Material name | ingredient | Ink 25 | Ink 26 | Ink 27 |
| Coloring | Pigment dispersion 1 | 20.0 | — | — | — |
| material | | percent | | | |
| | Pigment dispersion 2 | 20.0 | — | — | — |
| | | percent | | | |
| | Pigment dispersion 3 | 20.0 | — | — | — |
| | | percent | | | |
| | Pigment dispersion 4 | 20.0 | — | — | — |
| | | percent | | | |
| | Pigment dispersion 5 | 15.0 | — | 20.00 | — |
| | | percent | | | |
| | Pigment dispersion 6 | 15.0 | — | — | 6.67 |
| | | percent | | | |
| | Pigment dispersion 7 | 15.0 | — | — | — |
| | | percent | | | |
| | Pigment dispersion 8 | 15.0 | 20.00 | — | — |
| | | percent | | | |
| First resin | SUPERFLEX 420 | 32.0 | — | — | — |
| | | percent | | | |
| | SUPERFLEX 460 | 38.0 | — | — | — |
| | | percent | | | |
| | SUPERFLEX 470 | 38.0 | 1.58 | 1.58 | 2.63 |
| | | percent | | | |
| | TOCRYL BCX-8111 | 58.0 | — | — | — |
| | | percent | | | |
| | TOCRYL W-168 | 49.5 | 0.81 | 0.81 | 1.01 |
| | | percent | | | |
| | Hiros-X JE-1113 | 41.7 | — | — | — |
| | | percent | | | |
| | Solids content of first resin | | 1.00 | 1.00 | 1.50 |
| Second resin | SUPERFLEX 170 | 33.0 | — | — | — |
| | | percent | | | |
| | TAKELAC W-5661 | 35.0 | — | — | — |
| | | percent | | | |
| | TAKELAC W-6020 | 30.0 | — | — | — |
| | | percent | | | |
| | Hiros-X JE-1056 | 43.5 | 25.29 | 25.29 | 29.89 |
| | | percent | | | |
| | Hiros-X KE-1062 | 42.6 | — | — | — |
| | | percent | | | |
| | TOCRYL W-3080 | 41.8 | — | — | — |
| | | percent | | | |
| | Solids content of second resin | | 11.00 | 11.00 | 13.00 |
| Organic | Glycerin | 100 | — | — | — |
| solvent | | percent | | | |
| | Ethylene glycol | 100 | — | — | — |
| | | percent | | | |
| | 3-methyl-1,3-butane | 100 | — | — | — |
| | diol | percent | | | |
| | 1,2-hexane diol | 100 | — | — | — |
| | | percent | | | |
| | 1,2-butanediol | 100 | 10.00 | 10.00 | 10.00 |
| | | percent | | | |
| | 2,3-Butane diol | 100 | — | — | — |
| | | percent | | | |
| | 1,2-propane diol | 100 | 5.00 | 5.00 | 5.00 |
| | | percent | | | |
| | 1-methoxy-2- | 100 | — | — | — |
| | propanol | percent | | | |
| | 1-ethoxy-2-propanol | 100 | — | — | 3.00 |
| | | percent | | | |
| | 1-propoxy-2- | 100 | 5.00 | 5.00 | 5.00 |
| | propanol | percent | | | |
| | 3-methoxy-1-butanol | 100 | — | — | — |
| | | percent | | | |
| | 3-methoxy-3-methyl- | 100 | — | — | — |
| | 1-butanol | percent | | | |
| | Ethylene glycol | 100 | 1.00 | 1.00 | 1.00 |
| | monobutyl ether | percent | | | |
| | Ethylene glycol | 100 | — | — | — |
| | monobutyl ether | percent | | | |
| Cation-based | Wax Emulsion 1 | 30 | — | — | — |
| polyethylene | | percent | | | |
| wax | Wax Emulsion 2 | 30 | — | — | — |
| | | percent | | | |
| | Wax Emulsion 3 | 30 | — | — | — |
| | | percent | | | |
| | AQUACER 840 | 35 | 1.43 | 2.14 | 1.43 |
| | | percent | | | |
| Other wax | AQUACER 537 | 30 | — | — | — |
| | | percent | | | |
| | AQUACER 531 | 45 | — | — | — |
| | | percent | | | |
| | AQUACER 593 | 30 | — | — | — |
| | | percent | | | |
| Surfactant | TEGO Wet 270 | 100 | — | — | — |
| | | percent | | | |
| | SILFACE SAG503A | 100 | 0.30 | 0.30 | 0.30 |
| | | percent | | | |
| | Surfynol 465 | 100 | — | — | — |
| | | percent | | | |
| | Capstone FS3100 | 100 | — | — | — |
| | | percent | | | |
| Mildew- | Proxel GXL | 20 | 0.05 | 0.05 | 0.05 |
| proofing | | percent | | | |
| agent | | | | | |
| Foam | 2,4,7,9-tetramethyl | 100 | — | — | — |
| inhibitor | decane-4,7-diol | percent | | | |
| (defoaming | 2,5,8,11- | 100 | 0.30 | 0.30 | 0.30 |
| agent) | tetramethyldodecane- | percent | | | |
| | 5,8-diol | | | | |
| pH regulator | 2-amino-2-ethyl-1,3- | 100 | 0.30 | 0.30 | 0.30 |
| | propane diol | percent | | | |
| Pure water | | | Balance | Balance | Balance |
| Total | | | 100 | 100 | 100 |
| Material | | | | | |
| | | Active | | | |
| Classification | Material name | ingredient | Ink 20 | Ink 21 | Ink 22 |
| Coloring | Pigment dispersion 1 | 20.0 | — | — | — |
| material | | percent | | | |
| | Pigment dispersion 2 | 20.0 | — | — | — |
| | | percent | | | |
| | Pigment dispersion 3 | 20.0 | — | — | — |
| | | percent | | | |
| | Pigment dispersion 4 | 20.0 | — | — | — |
| | | percent | | | |
| | Pigment dispersion 5 | 15.0 | — | — | 33.33 |
| | | percent | | | |
| | Pigment dispersion 6 | 15.0 | — | — | — |
| | | percent | | | |
| | Pigment dispersion 7 | 15.0 | 13.33 | — | — |
| | | percent | | | |
| | Pigment dispersion 8 | 15.0 | — | 33.33 | — |
| | | percent | | | |
| First resin | SUPERFLEX 420 | 32.0 | — | — | — |
| | | percent | | | |
| | SUPERFLEX 460 | 38.0 | 3.95 | — | — |
| | | percent | | | |
| | SUPERFLEX 470 | 38.0 | — | 1.58 | 1.58 |
| | | percent | | | |
| | TOCRYL BCX-8111 | 58.0 | — | — | — |
| | | percent | | | |
| | TOCRYL W-168 | 49.5 | — | — | — |
| | | percent | | | |
| | Hiros-X JE-1113 | 41.7 | — | — | — |
| | | percent | | | |
| | Solids content of first resin | | 1.50 | 0.60 | 0.60 |
| Second resin | SUPERFLEX 170 | 33.0 | — | — | — |
| | | percent | | | |
| | TAKELAC W-5661 | 35.0 | — | — | — |
| | | percent | | | |
| | TAKELAC W-6020 | 30.0 | — | — | — |
| | | percent | | | |
| | Hiros-X JE-1056 | 43.5 | 25.29 | — | — |
| | | percent | | | |
| | Hiros-X KE-1062 | 42.6 | — | 14.08 | 14.08 |
| | | percent | | | |
| | TOCRYL W-3080 | 41.8 | — | 1.20 | 1.20 |
| | | percent | | | |
| | Solids content of second resin | | 11.00 | 6.50 | 6.50 |
| Organic | Glycerin | 100 | — | — | — |
| solvent | | percent | | | |
| | Ethylene glycol | 100 | — | 5.00 | 5.00 |
| | | percent | | | |
| | 3-methyl-1,3-butane | 100 | — | — | — |
| | diol | percent | | | |
| | 1,2-hexane diol | 100 | — | — | — |
| | | percent | | | |
| | 1,2-butanediol | 100 | 5.00 | — | — |
| | | percent | | | |
| | 2,3-butanediol | 100 | — | — | — |
| | | percent | | | |
| | 1,2-propane diol | 100 | 10.00 | 10.00 | 10.00 |
| | | percent | | | |
| | 1-methoxy-2-propanol | 100 | — | 2.00 | 2.00 |
| | | percent | | | |
| | 1-ethoxy-2-propanol | 100 | — | — | — |
| | | percent | | | |
| | 1-propoxy-2-propanol | 100 | — | — | — |
| | | percent | | | |
| | 3-methoxy-1-butanol | 100 | — | 5.00 | 5.00 |
| | | percent | | | |
| | 3-methoxy-3-methyl- | 100 | 5.00 | — | — |
| | 1-butanol | percent | | | |
| | Ethylene glycol | 100 | — | 1.00 | 1.00 |
| | monobutyl ether | percent | | | |
| | Ethylene glycol | 100 | 3.00 | — | — |
| | monobutyl ether | percent | | | |
| Cation-based | Wax Emulsion 1 | 30 | — | — | — |
| polyethylene | | percent | | | |
| wax | Wax Emulsion 2 | 30 | — | — | — |
| | | percent | | | |
| | Wax Emulsion 3 | 30 | — | 3.33 | 3.33 |
| | | percent | | | |
| | AQUACER 840 | 35 | 2.14 | — | — |
| | | percent | | | |
| Other wax | AQUACER 537 | 30 | — | — | — |
| | | percent | | | |
| | AQUACER 531 | 45 | — | — | — |
| | | percent | | | |
| | AQUACER 593 | 30 | — | — | — |
| | | percent | | | |
| Surfactant | TEGO Wet 270 | 100 | 0.10 | — | — |
| | | percent | | | |
| | SILFACE SAG503A | 100 | 0.50 | — | — |
| | | percent | | | |
| | Surfynol 465 | 100 | — | 1.0 | 1.0 |
| | | percent | | | |
| | Capstone FS3100 | 100 | — | — | — |
| | | percent | | | |
| Mildew- | Proxel GXL | 20 | 0.05 | 0.05 | 0.05 |
| proofing | | percent | | | |
| agent | | | | | |
| Foam | 2,4,7,9-tetramethyl | 100 | 0.30 | — | — |
| inhibitor | decane-4,7-diol | percent | | | |
| (defoaming | 2,5,8,11- | 100 | — | 0.10 | 0.10 |
| agent) | tetramethyldodecane- | percent | | | |
| | 5,8-diol | | | | |
| pH regulator | 2-amino-2-ethyl-1,3- | 100 | 0.30 | 0.20 | 0.20 |
| | propane diol | percent | | | |

| | | | |
|---|---|---|---|
| Pure water | Balance | Balance | Balance |
| Total | 100 | 100 | 100 |

| Material | | | | |
|---|---|---|---|---|
| | | Active | | |
| Classification | Material name | ingredient | Ink 23 | Ink 24 |
| Coloring | Pigment dispersion 1 | 20.0 | — | — |
| material | | percent | | |
| | Pigment dispersion 2 | 20.0 | — | — |
| | | percent | | |
| | Pigment dispersion 3 | 20.0 | — | — |
| | | percent | | |
| | Pigment dispersion 4 | 20.0 | — | — |
| | | percent | | |
| | Pigment dispersion 5 | 15.0 | — | — |
| | | percent | | |
| | Pigment dispersion 6 | 15.0 | 13.33 | — |
| | | percent | | |
| | Pigment dispersion 7 | 15.0 | — | 20.00 |
| | | percent | | |
| | Pigment dispersion 8 | 15.0 | — | — |
| | | percent | | |
| First resin | SUPERFLEX 420 | 32.0 | — | — |
| | | percent | | |
| | SUPERFLEX 460 | 38.0 | — | — |
| | | percent | | |
| | SUPERFLEX 470 | 38.0 | 2.63 | 2.63 |
| | | percent | | |
| | TOCRYL BCX-8111 | 58.0 | — | — |
| | | percent | | |
| | TOCRYL W-168 | 49.5 | — | — |
| | | percent | | |
| | Hiros-X JE-1113 | 41.7 | — | — |
| | | percent | | |

| | | |
|---|---|---|
| Solids content of first resin | 1.00 | 1.00 |

| | | | | |
|---|---|---|---|---|
| Second resin | SUPERFLEX 170 | 33.0 | — | — |
| | | percent | | |
| | TAKELAC W-5661 | 35.0 | — | — |
| | | percent | | |
| | TAKELAC W-6020 | 30.0 | — | — |
| | | percent | | |
| | Hiros-X JE-1056 | 43.5 | — | — |
| | | percent | | |
| | Hiros-X KE-1062 | 42.6 | 18.78 | 18.78 |
| | | percent | | |
| | TOCRYL W-3080 | 41.8 | 1.20 | 1.20 |
| | | percent | | |

| | | |
|---|---|---|
| Solids content of second resin | 8.50 | 8.50 |

| | | | | |
|---|---|---|---|---|
| Organic | Glycerin | 100 | — | — |
| solvent | | percent | | |
| | Ethylene glycol | 100 | 5.00 | 5.00 |
| | | percent | | |
| | 3-methyl-1,3-butane | 100 | 2.00 | — |
| | diol | percent | | |
| | 1,2-hexane diol | 100 | — | — |
| | | percent | | |
| | 1,2-butanediol | 100 | — | — |
| | | percent | | |
| | 2,3-butanediol | 100 | — | — |
| | | percent | | |
| | 1,2-propane diol | 100 | 10.00 | 10.00 |
| | | percent | | |
| | 1-methoxy-2-propanol | 100 | 2.00 | 2.00 |
| | | percent | | |
| | 1-ethoxy-2-propanol | 100 | — | — |
| | | percent | | |
| | 1-propoxy-2-propanol | 100 | — | — |
| | | percent | | |
| | 3-methoxy-1-butanol | 100 | 5.00 | 5.00 |
| | | percent | | |
| | 3-methoxy-3-methyl- | 100 | — | — |
| | 1-butanol | percent | | |
| | Ethylene glycol | 100 | 1.00 | 1.00 |
| | monobutyl ether | percent | | |
| | Ethylene glycol | 100 | — | — |
| | monobutyl ether | percent | | |
| Cation-based | Wax Emulsion 1 | 30 | — | — |
| polyethylene | | percent | | |
| wax | Wax Emulsion 2 | 30 | — | — |
| | | percent | | |
| | Wax Emulsion 3 | 30 | 3.33 | 3.33 |
| | | percent | | |
| | AQUACER 840 | 35 | — | — |
| | | percent | | |
| Other wax | AQUACER 537 | 30 | — | — |
| | | percent | | |
| | AQUACER 531 | 45 | — | — |
| | | percent | | |
| | AQUACER 593 | 30 | — | — |
| | | percent | | |
| Surfactant | TEGO Wet 270 | 100 | — | — |
| | | percent | | |
| | SILFACE SAG503A | 100 | — | — |
| | | percent | | |
| | Surfynol 465 | 100 | 1.0 | 1.0 |
| | | percent | | |
| | Capstone FS3100 | 100 | — | — |
| | | percent | | |
| Mildew- | Proxel GXL | 20 | 0.05 | 0.05 |
| proofing | | percent | | |
| agent | | | | |
| Foam | 2,4,7,9-tetramethyl | 100 | — | — |
| inhibitor | decane-4,7-diol | percent | | |
| (defoaming | 2,5,8,11- | 100 | 0.10 | 0.10 |
| agent) | tetramethyldodecane- | percent | | |
| | 5,8-diol | | | |
| pH regulator | 2-amino-2-ethyl-1,3- | 100 | 0.20 | 0.20 |
| | propane diol | percent | | |

| | | |
|---|---|---|
| Pure water | Balance | Balance |
| Total | 100 | 100 |

TABLE 6

| Material | | | | | |
|---|---|---|---|---|---|
| | | Active | | | |
| Classification | Material name | ingredient | Ink 33 | Ink 34 | Ink 35 |
| Coloring | Pigment dispersion 1 | 20.0 | — | — | — |
| material | | percent | | | |
| | Pigment dispersion 2 | 20.0 | — | — | — |
| | | percent | | | |
| | Pigment dispersion 3 | 20.0 | — | — | — |
| | | percent | | | |
| | Pigment dispersion 4 | 20.0 | — | — | — |
| | | percent | | | |
| | Pigment dispersion 5 | 15.0 | — | 33.33 | — |
| | | percent | | | |
| | Pigment dispersion 6 | 15.0 | — | — | 13.33 |
| | | percent | | | |
| | Pigment dispersion 7 | 15.0 | — | — | — |
| | | percent | | | |
| | Pigment dispersion 8 | 15.0 | 33.33 | — | — |
| | | percent | | | |
| First resin | SUPERFLEX 420 | 32.0 | — | — | — |
| | | percent | | | |
| | SUPERFLEX 460 | 38.0 | — | — | — |
| | | percent | | | |
| | SUPERFLEX 470 | 38.0 | 1.58 | 1.58 | 2.63 |
| | | percent | | | |
| | TOCRYL BCX-8111 | 58.0 | — | — | — |
| | | percent | | | |
| | TOCRYL W-168 | 49.5 | — | — | — |
| | | percent | | | |
| | Hiros-X JE-1113 | 41.7 | — | — | — |
| | | percent | | | |
| | Solids content of first resin | | 0.60 | 0.60 | 1.00 |
| Second resin | SUPERFLEX 170 | 33.0 | — | — | — |
| | | percent | | | |
| | TAKELAC W-5661 | 35.0 | — | — | — |
| | | percent | | | |
| | TAKELAC W-6020 | 30.0 | — | — | — |
| | | percent | | | |
| | Hiros-X JE-1056 | 43.5 | — | — | — |
| | | percent | | | |
| | Hiros-X KE-1062 | 42.6 | 14.08 | 14.08 | 18.78 |
| | | percent | | | |
| | TOCRYL W-3080 | 41.8 | 1.20 | 1.20 | 1.20 |
| | | percent | | | |
| | Solids content of second resin | | 6.50 | 6.50 | 8.50 |
| Organic | Glycerin | 100 | — | — | — |
| solvent | | percent | | | |
| | Ethylene glycol | 100 | 5.00 | 5.00 | 5.00 |
| | | percent | | | |
| | 3-methyl-1,3-butane | 100 | — | — | 2.00 |
| | diol | percent | | | |
| | 1,2-hexane diol | 100 | — | — | — |
| | | percent | | | |
| | 1,2-butanediol | 100 | — | — | — |
| | | percent | | | |
| | 2,3-butanediol | 100 | — | — | — |
| | | percent | | | |
| | 1,2-propane diol | 100 | 10.00 | 10.00 | 10.00 |
| | | percent | | | |
| | 1-methoxy-2- | 100 | 2.00 | 2.00 | 2.00 |
| | propanol | percent | | | |
| | 1-ethoxy-2-propanol | 100 | — | — | — |
| | | percent | | | |
| | 1-propoxy-2- | 100 | — | — | — |
| | propanol | percent | | | |
| | 3-methoxy-1-butanol | 100 | 5.00 | 5.00 | 5.00 |
| | | percent | | | |
| | 3-methoxy-3-methyl- | 100 | — | — | — |
| | 1-butanol | percent | | | |
| | Ethylene glycol | 100 | 1.00 | 1.00 | 1.00 |
| | monobutyl ether | percent | | | |
| | Ethylene glycol | 100 | — | — | — |
| | monobutyl ether | percent | | | |
| Cation-based | Wax Emulsion 1 | 30 | — | — | — |
| polyethylene | | percent | | | |
| wax | Wax Emulsion 2 | 30 | — | — | — |
| | | percent | | | |
| | Wax Emulsion 3 | 30 | — | — | — |
| | | percent | | | |
| | AQUACER 840 | 35 | — | — | — |
| | | percent | | | |
| Other wax | AQUACER 537 | 30 | 3.33 | 3.33 | 3.33 |
| | | percent | | | |
| | AQUACER 531 | 45 | — | — | — |
| | | percent | | | |
| | AQUACER 593 | 30 | — | — | — |
| | | percent | | | |
| Surfactant | TEGO Wet 270 | 100 | — | — | — |
| | | percent | | | |
| | SILFACE SAG503A | 100 | — | — | — |
| | | percent | | | |
| | Surfynol 465 | 100 | 1.00 | 1.00 | 1.00 |
| | | percent | | | |
| | Capstone FS3100 | 100 | — | — | — |
| | | percent | | | |
| Mildew- | Proxel GXL | 20 | 0.05 | 0.05 | 0.05 |
| proofing | | percent | | | |
| agent | | | | | |
| Foam | 2,4,7,9-tetramethyl | 100 | — | — | — |
| inhibitor | decane-4,7-diol | percent | | | |
| (defoaming | 2,5,8,11- | 100 | 0.10 | 0.10 | 0.10 |
| agent) | tetramethyldodecane- | percent | | | |
| | 5,8-diol | | | | |
| pH regulator | 2-amino-2-ethyl-1,3- | 100 | 0.20 | 0.20 | 0.20 |
| | propane diol | percent | | | |
| Pure water | | | Balance | Balance | Balance |
| Total | | | 100 | 100 | 100 |
| Material | | | | | |
| | | Active | | | |
| Classification | Material name | ingredient | Ink 36 | Ink 37 | Ink 38 |
| Coloring | Pigment dispersion 1 | 20.0 | — | — | — |
| material | | percent | | | |
| | Pigment dispersion 2 | 20.0 | — | — | — |
| | | percent | | | |
| | Pigment dispersion 3 | 20.0 | — | — | — |
| | | percent | | | |
| | Pigment dispersion 4 | 20.0 | — | — | — |
| | | percent | | | |
| | Pigment dispersion 5 | 15.0 | — | — | 33.33 |
| | | percent | | | |
| | Pigment dispersion 6 | 15.0 | — | — | — |
| | | percent | | | |
| | Pigment dispersion 7 | 15.0 | 20.00 | — | — |
| | | percent | | | |
| | Pigment dispersion 8 | 15.0 | — | 33.33 | — |
| | | percent | | | |
| First resin | SUPERFLEX 420 | 32.0 | — | — | — |
| | | percent | | | |
| | SUPERFLEX 460 | 38.0 | — | — | — |
| | | percent | | | |
| | SUPERFLEX 470 | 38.0 | 2.63 | 1.58 | 1.58 |
| | | percent | | | |
| | TOCRYL BCX-8111 | 58.0 | — | — | — |
| | | percent | | | |
| | TOCRYL W-168 | 49.5 | — | — | — |
| | | percent | | | |
| | Hiros-X JE-1113 | 41.7 | — | — | — |
| | | percent | | | |
| | Solids content of first resin | | 1.00 | 0.60 | 0.60 |
| Second resin | SUPERFLEX 170 | 33.0 | — | — | — |
| | | percent | | | |
| | TAKELAC W-5661 | 35.0 | — | — | — |
| | | percent | | | |
| | TAKELAC W-6020 | 30.0 | — | — | — |
| | | percent | | | |
| | Hiros-X JE-1056 | 43.5 | — | — | — |
| | | percent | | | |
| | Hiros-X KE-1062 | 42.6 | 18.78 | 14.08 | 14.08 |
| | | percent | | | |
| | TOCRYL W-3080 | 41.8 | 1.20 | 1.20 | 1.20 |
| | | percent | | | |
| | Solids content of second resin | | 8.50 | 6.50 | 6.50 |
| Organic | Glycerin | 100 | — | — | — |
| solvent | | percent | | | |
| | Ethylene glycol | 100 | 5.00 | 5.00 | 5.00 |
| | | percent | | | |
| | 3-methyl-1,3-butane | 100 | — | — | — |
| | diol | percent | | | |
| | 1,2-hexane diol | 100 | — | — | — |
| | | percent | | | |
| | 1,2-butanediol | 100 | — | — | — |
| | | percent | | | |
| | 2,3-butanediol | 100 | — | — | — |
| | | percent | | | |
| | 1,2-propane diol | 100 | 10.00 | 10.00 | 10.00 |
| | | percent | | | |
| | 1-methoxy-2- | 100 | 2.00 | 2.00 | 2.00 |
| | propanol | percent | | | |
| | 1-ethoxy-2-propanol | 100 | — | — | — |
| | | percent | | | |
| | 1-propoxy-2- | 100 | — | — | — |
| | propanol | percent | | | |
| | 3-methoxy-1-butanol | 100 | 5.00 | 5.00 | 5.00 |
| | | percent | | | |
| | 3-methoxy-3-methyl- | 100 | — | — | — |
| | 1-butanol | percent | | | |
| | Ethylene glycol | 100 | 1.00 | 1.00 | 1.00 |
| | monobutyl ether | percent | | | |
| | Ethylene glycol | 100 | — | — | — |
| | monobutyl ether | percent | | | |
| Cation-based | Wax Emulsion 1 | 30 | — | — | — |
| polyethylene | | percent | | | |
| wax | Wax Emulsion 2 | 30 | — | — | — |
| | | percent | | | |
| | Wax Emulsion 3 | 30 | — | — | — |
| | | percent | | | |
| | AQUACER 840 | 35 | — | — | — |
| | | percent | | | |
| Other wax | AQUACER 537 | 30 | 3.33 | — | — |
| | | percent | | | |
| | AQUACER 531 | 45 | — | 2.22 | 2.22 |
| | | percent | | | |
| | AQUACER 593 | 30 | — | — | — |
| | | percent | | | |
| Surfactant | TEGO Wet 270 | 100 | — | — | — |
| | | percent | | | |
| | SILFACE SAG503A | 100 | — | — | — |
| | | percent | | | |
| | Surfynol 465 | 100 | 1.00 | 1.00 | 1.00 |
| | | percent | | | |
| | Capstone FS3100 | 100 | — | — | — |
| | | percent | | | |
| Mildew- | Proxel GXL | 20 | 0.05 | 0.05 | 0.05 |
| proofing | | percent | | | |
| agent | | | | | |
| Foam | 2,4,7,9-tetramethyl | 100 | — | — | — |
| inhibitor | decane-4,7-diol | percent | | | |
| (defoaming | 2,5,8,11- | 100 | 0.10 | 0.10 | 0.10 |
| agent) | tetramethyldodecane- | percent | | | |
| | 5,8-diol | | | | |
| pH regulator | 2-amino-2-ethyl-1,3- | 100 | 0.20 | 0.20 | 0.20 |
| | propane diol | percent | | | |

| | | | |
|---|---|---|---|
| Pure water | Balance | Balance | Balance |
| Total | 100 | 100 | 100 |

| Material | | | | |
|---|---|---|---|---|
| | | Active | | |
| Classification | Material name | ingredient | Ink 39 | Ink 40 |
| Coloring | Pigment dispersion 1 | 20.0 | — | — |
| material | | percent | | |
| | Pigment dispersion 2 | 20.0 | — | — |
| | | percent | | |
| | Pigment dispersion 3 | 20.0 | — | — |
| | | percent | | |
| | Pigment dispersion 4 | 20.0 | — | — |
| | | percent | | |
| | Pigment dispersion 5 | 15.0 | — | — |
| | | percent | | |
| | Pigment dispersion 6 | 15.0 | 13.33 | — |
| | | percent | | |
| | Pigment dispersion 7 | 15.0 | — | 20.00 |
| | | percent | | |
| | Pigment dispersion 8 | 15.0 | — | — |
| | | percent | | |
| First resin | SUPERFLEX 420 | 32.0 | — | — |
| | | percent | | |
| | SUPERFLEX 460 | 38.0 | — | — |
| | | percent | | |
| | SUPERFLEX 470 | 38.0 | 2.63 | 2.63 |
| | | percent | | |
| | TOCRYL BCX-8111 | 58.0 | — | — |
| | | percent | | |
| | TOCRYL W-168 | 49.5 | — | — |
| | | percent | | |
| | Hiros-X JE-1113 | 41.7 | — | — |
| | | percent | | |

| | | |
|---|---|---|
| Solids content of first resin | 1.00 | 1.00 |

| | | | | |
|---|---|---|---|---|
| Second resin | SUPERFLEX 170 | 33.0 | — | — |
| | | percent | | |
| | TAKELAC W-5661 | 35.0 | — | — |
| | | percent | | |
| | TAKELAC W-6020 | 30.0 | — | — |
| | | percent | | |
| | Hiros-X JE-1056 | 43.5 | — | — |
| | | percent | | |
| | Hiros-X KE-1062 | 42.6 | 18.78 | 18.78 |
| | | percent | | |
| | TOCRYL W-3080 | 41.8 | 1.20 | 1.20 |
| | | percent | | |

| | | |
|---|---|---|
| Solids content of second resin | 8.50 | 8.50 |

| | | | | |
|---|---|---|---|---|
| Organic | Glycerin | 100 | — | — |
| solvent | | percent | | |
| | Ethylene glycol | 100 | 5.00 | 5.00 |
| | | percent | | |
| | 3-methyl-1,3-butane | 100 | 2.00 | — |
| | diol | percent | | |
| | 1,2-hexane diol | 100 | — | — |
| | | percent | | |
| | 1,2-butanediol | 100 | — | — |
| | | percent | | |
| | 2,3-butanediol | 100 | — | — |
| | | percent | | |
| | 1,2-propane diol | 100 | 10.00 | 10.00 |
| | | percent | | |
| | 1-methoxy-2- | 100 | 2.00 | 2.00 |
| | propanol | percent | | |
| | 1-ethoxy-2-propanol | 100 | — | — |
| | | percent | | |
| | 1-propoxy-2- | 100 | — | — |
| | propanol | percent | | |
| | 3-methoxy-1-butanol | 100 | 5.00 | 5.00 |
| | | percent | | |
| | 3-methoxy-3-methyl- | 100 | — | — |
| | 1-butanol | percent | | |
| | Ethylene glycol | 100 | 1.00 | 1.00 |
| | monobutyl ether | percent | | |
| | Ethylene glycol | 100 | — | — |
| | monobutyl ether | percent | | |
| Cation-based | Wax Emulsion 1 | 30 | — | — |
| polyethylene | | percent | | |
| wax | Wax Emulsion 2 | 30 | — | — |
| | | percent | | |
| | Wax Emulsion 3 | 30 | — | — |
| | | percent | | |
| | AQUACER 840 | 35 | — | — |
| | | percent | | |
| Other wax | AQUACER 537 | 30 | — | — |
| | | percent | | |
| | AQUACER 531 | 45 | 2.22 | 2.22 |
| | | percent | | |
| | AQUACER 593 | 30 | — | — |
| | | percent | | |
| Surfactant | TEGO Wet 270 | 100 | — | — |
| | | percent | | |
| | SILFACE SAG503A | 100 | — | — |
| | | percent | | |
| | Surfynol 465 | 100 | 1.00 | 1.00 |
| | | percent | | |
| | Capstone FS3100 | 100 | — | — |
| | | percent | | |
| Mildew- | Proxel GXL | 20 | 0.05 | 0.05 |
| proofing | | percent | | |
| agent | | | | |
| Foam | 2,4,7,9-tetramethyl | 100 | — | — |
| inhibitor | decane-4,7-diol | percent | | |
| (defoaming | 2,5,8,11- | 100 | 0.10 | 0.10 |
| agent) | tetramethyldodecane- | percent | | |
| | 5,8-diol | | | |
| pH regulator | 2-amino-2-ethyl-1,3- | 100 | 0.20 | 0.20 |
| | propane diol | percent | | |

| | | |
|---|---|---|
| Pure water | Balance | Balance |
| Total | 100 | 100 |

TABLE 7

| Material | | | | |
|---|---|---|---|---|
| Classification | Material name | Active ingredient | Ink 41 | Ink 42 |
| Coloring | Pigment | 20.0 | — | — |
| material | Dispersion 1 | percent | | |
| | Pigment | 20.0 | — | — |
| | Dispersion 2 | percent | | |
| | Pigment | 20.0 | — | — |
| | Dispersion 3 | percent | | |
| | Pigment | 20.0 | — | — |
| | Dispersion 4 | percent | | |
| | Pigment | 15.0 | — | 33.33 |
| | Dispersion 5 | percent | | |
| | Pigment | 15.0 | — | — |
| | Dispersion 6 | percent | | |
| | Pigment | 15.0 | — | — |
| | Dispersion 7 | percent | | |
| | Pigment | 15.0 | 33.33 | — |
| | Dispersion 8 | percent | | |
| First resin | SUPERFLEX 420 | 32.0 | — | — |
| | | percent | | |
| | SUPERFLEX 460 | 38.0 | — | — |
| | | percent | | |
| | SUPERFLEX 470 | 38.0 | 1.58 | 1.58 |
| | | percent | | |
| | TOCRYL BCX-8111 | 58.0 | — | — |
| | | percent | | |
| | TOCRYL W-168 | 49.5 | — | — |
| | | percent | | |
| | Hiros-X JE-1113 | 41.7 | — | — |
| | | percent | | |
| | Solids content of first resin | | 0.60 | 0.60 |
| Second resin | SUPERFLEX 170 | 33.0 | — | — |
| | | percent | | |
| | TAKELAC W-5661 | 35.0 | — | — |
| | | percent | | |
| | TAKELAC W-6020 | 30.0 | — | — |
| | | percent | | |
| | Hiros-X JE-1056 | 43.5 | — | — |
| | | percent | | |
| | Hiros-X KE-1062 | 42.6 | 14.08 | 14.08 |
| | | percent | | |
| | TOCRYL W-3080 | 41.8 | 1.20 | 1.20 |
| | | percent | | |
| | Solids content of second resin | | 6.50 | 6.50 |
| Organic | Glycerin | 100 | — | — |
| solvent | | percent | | |
| | Ethylene glycol | 100 | 5.00 | 5.00 |
| | | percent | | |
| | 3-methyl-1,3-butane | 100 | — | — |
| | diol | percent | | |
| | 1,2-hexane diol | 100 | — | — |
| | | percent | | |
| | 1,2-butanediol | 100 | — | — |
| | | percent | | |
| | 2,3-butanediol | 100 | — | — |
| | | percent | | |
| | 1,2-propane diol | 100 | 10.00 | 10.00 |
| | | percent | | |
| | 1-methoxy-2- | 100 | 2.00 | 2.00 |
| | propanol | percent | | |
| | 1-ethoxy-2-propanol | 100 | — | — |
| | | percent | | |
| | 1-propoxy-2- | 100 | — | — |
| | propanol | percent | | |
| | 3-methoxy-1-butanol | 100 | 5.00 | 5.00 |
| | | percent | | |
| | 3-methoxy-3-methyl- | 100 | — | — |
| | 1-butanol | percent | | |
| | Ethylene glycol | 100 | 1.00 | 1.00 |
| | monobutyl ether | percent | | |
| | Ethylene glycol | 100 | — | — |
| | monobutyl ether | percent | | |
| Cation-based | Wax Emulsion 1 | 30 | — | — |
| polyethylene | | percent | | |
| wax | Wax Emulsion 2 | 30 | — | — |
| | | percent | | |
| | Wax Emulsion 3 | 30 | — | — |
| | | percent | | |
| | AQUACER 840 | 35 | — | — |
| | | percent | | |
| Other wax | AQUACER 537 | 30 | — | — |
| | | percent | | |
| | AQUACER 531 | 45 | — | — |
| | | percent | | |
| | AQUACER 593 | 30 | 3.33 | 3.33 |
| | | percent | | |
| Surfactant | TEGO Wet 270 | 100 | — | — |
| | | percent | | |
| | SILFACE SAG503A | 100 | — | — |
| | | percent | | |
| | Surfynol 465 | 100 | 1.00 | 1.00 |
| | | percent | | |
| | Capstone FS3100 | 100 | — | — |
| | | percent | | |
| Mildew- | Proxel GXL | 20 | 0.05 | 0.05 |
| proofing | | percent | | |
| agent | | | | |
| Foam | 2,4,7,9-tetramethyl | 100 | — | — |
| inhibitor | decane-4,7-diol | percent | | |
| (defoaming | 2,5,8,11- | 100 | 0.10 | 0.10 |
| agent) | tetramethyl- | percent | | |
| | dodecane- | | | |
| | 5,8-diol | | | |
| pH regulator | 2-amino-2-ethyl- | 100 | 0.20 | 0.20 |
| | 1,3-propane diol | percent | | |
| Pure water | | | Balance | Balance |
| Total | | | 100 | 100 |
| Material | | | | |
| Classification | Material name | Active ingredient | Ink 43 | Ink 44 |
| Coloring | Pigment | 20.0 | — | — |
| material | Dispersion 1 | percent | | |
| | Pigment | 20.0 | — | — |
| | Dispersion 2 | percent | | |
| | Pigment | 20.0 | — | — |
| | Dispersion 3 | percent | | |
| | Pigment | 20.0 | — | — |
| | Dispersion 4 | percent | | |
| | Pigment | 15.0 | — | — |
| | Dispersion 5 | percent | | |
| | Pigment | 15.0 | 13.33 | — |
| | Dispersion 6 | percent | | |
| | Pigment | 15.0 | — | 20.00 |
| | Dispersion 7 | percent | | |
| | Pigment | 15.0 | — | — |
| | Dispersion 8 | percent | | |
| First resin | SUPERFLEX 420 | 32.0 | — | — |
| | | percent | | |
| | SUPERFLEX 460 | 38.0 | — | — |
| | | percent | | |
| | SUPERFLEX 470 | 38.0 | 2.63 | 2.63 |
| | | percent | | |
| | TOCRYL BCX-8111 | 58.0 | — | — |
| | | percent | | |
| | TOCRYL W-168 | 49.5 | — | — |
| | | percent | | |
| | Hiros-X JE-1113 | 41.7 | — | — |
| | | percent | | |
| | Solids content of first resin | | 1.00 | 1.00 |
| Second resin | SUPERFLEX 170 | 33.0 | — | — |
| | | percent | | |
| | TAKELAC W-5661 | 35.0 | — | — |
| | | percent | | |
| | TAKELAC W-6020 | 30.0 | — | — |
| | | percent | | |
| | Hiros-X JE-1056 | 43.5 | — | — |
| | | percent | | |
| | Hiros-X KE-1062 | 42.6 | 18.78 | 18.78 |
| | | percent | | |
| | TOCRYL W-3080 | 41.8 | 1.20 | 1.20 |
| | | percent | | |
| | Solids content of second resin | | 8.50 | 8.50 |
| Organic | Glycerin | 100 | — | — |
| solvent | | percent | | |
| | Ethylene glycol | 100 | 5.00 | 5.00 |
| | | percent | | |
| | 3-methyl-1,3-butane | 100 | 2.00 | — |
| | diol | percent | | |
| | 1,2-hexane diol | 100 | — | — |
| | | percent | | |
| | 1,2-butanediol | 100 | — | — |
| | | percent | | |
| | 2,3-butanediol | 100 | — | — |
| | | percent | | |
| | 1,2-propane diol | 100 | 10.00 | 10.00 |
| | | percent | | |
| | 1-methoxy-2- | 100 | 2.00 | 2.00 |
| | propanol | percent | | |
| | 1-ethoxy-2-propanol | 100 | — | — |
| | | percent | | |
| | 1-propoxy-2- | 100 | — | — |
| | propanol | percent | | |
| | 3-methoxy-1-butanol | 100 | 5.00 | 5.00 |
| | | percent | | |
| | 3-methoxy-3-methyl- | 100 | — | — |
| | 1-butanol | percent | | |
| | Ethylene glycol | 100 | 1.00 | 1.00 |
| | monobutyl ether | percent | | |
| | Ethylene glycol | 100 | — | — |
| | monobutyl ether | percent | | |
| Cation-based | Wax Emulsion 1 | 30 | — | — |
| polyethylene | | percent | | |
| wax | Wax Emulsion 2 | 30 | — | — |
| | | percent | | |
| | Wax Emulsion 3 | 30 | — | — |
| | | percent | | |
| | AQUACER 840 | 35 | — | — |
| | | percent | | |
| Other wax | AQUACER 537 | 30 | — | — |
| | | percent | | |
| | AQUACER 531 | 45 | — | — |
| | | percent | | |
| | AQUACER 593 | 30 | 3.33 | 3.33 |
| | | percent | | |
| Surfactant | TEGO Wet 270 | 100 | — | — |
| | | percent | | |
| | SILFACE SAG503A | 100 | — | — |
| | | percent | | |
| | Surfynol 465 | 100 | 1.00 | 1.00 |
| | | percent | | |
| | Capstone FS3100 | 100 | — | — |
| | | percent | | |
| Mildew- | Proxel GXL | 20 | 0.05 | 0.05 |
| proofing | | percent | | |
| agent | | | | |
| Foam | 2,4,7,9-tetramethyl | 100 | — | — |
| inhibitor | decane-4,7-diol | percent | | |
| (defoaming | 2,5,8,11- | 100 | 0.10 | 0.10 |
| agent) | tetramethyl- | percent | | |
| | dodecane- | | | |
| | 5,8-diol | | | |
| pH regulator | 2-amino-2-ethyl- | 100 | 0.20 | 0.20 |
| | 1,3-propane diol | percent | | |

| | | |
|---|---|---|
| Pure water | Balance | Balance |
| Total | 100 | 100 |

The details of each material shown in Tables 2 to 7 are as follows.

### First Resin

Superflex 420: urethane resin (Tg: −10 degrees Celsius, volume average particle diameter: 10 nm, solid content: 32 percent by mass, available from DKS Co. Ltd.)
Superflex 460: urethane resin (Tg: −21 degrees Celsius, volume average particle diameter: 40 nm, solid content: 38 percent by mass, available from DKS Co. Ltd.)
Superflex 470: urethane resin (Tg: −31 degrees Celsius, volume average particle diameter: 10 nm, solid content: 38 percent by mass, available from DKS Co. Ltd.)
TOCRYL BCX-8111: acrylic resin, Tg: −30 degrees Celsius, solid content: 58 percent by mass, available from artienceon)
TOCRYL W-168: acrylic resin, Tg: −30 degrees Celsius, solid content: 49.5 percent by mass, available from artienceon)
Hiros JE-1113: Acrylic resin, Tg: −24 degrees Celsius, volume average particle diameter: 60 nm, solid content: 41.7 percent by mass, available from SEIKO PMC Corporation

### Second Resin

Superflex 170: urethane resin emulsion (Tg: 75 degrees Celsius, volume average particle diameter: 10 nm, solid content: 33 percent by mass, available from DKS Co. Ltd.)
TAKELAC W-5661: urethane resin emulsion (Tg: 70 degrees Celsius, volume average particle diameter: 30 nm, solid content: 35 percent by mass, available from Mitsui Chemicals, Inc.)
TAKELAC W-6020: urethane resin emulsion (Tg: 90 degrees Celsius, volume average particle diameter: 80 nm, solid content: 30 percent by mass, available from Mitsui Chemicals, Inc.)
Hiros JE-1056: Acrylic resin (Tg: 82 degrees Celsius, volume average particle diameter: 50 nm, solid content: 43.5 percent by mass, available from SEIKO PMC Corporation
Hiros X KE-1062: Acrylic resin (Tg: 96 degrees Celsius, volume average particle diameter: 80 nm, solid content: 42.6 percent by mass, available from SEIKO PMC Corporation
TOCRYL W-3080: acrylic resin (Tg: 70 degrees Celsius, volume average particle diameter: 100 nm, solid content: 41.8 percent by mass, available from artienceon)

### Organic Solvent

Glycerin (SP value: 16.38, boiling point: 290 degrees Celsius, equilibrium moisture content: 49 percent by mass), ethylene glycol (SP value: 14.1, boiling point: 197.3 degrees Celsius, equilibrium moisture content: 44 percent by mass)
3-Methyl-1,3-butane diol (SP value: 12.05. Boiling point 203 degrees Celsius)
1,2-hexane diol (SP value: 11.80, boiling point: 223 degrees Celsius)
1,2-hexane diol (SP value: 12.75, boiling point: 192 degrees Celsius)
2,3-Butane diol (SP value: 12.55, boiling point: 177 degrees Celsius)
1,2-propane diol (SP value: 13.48, boiling point: 188.2 degrees Celsius)
1,2-methoxy-2-propanol (SP value: 10.41, boiling point: 120 degrees Celsius)
1-ethoxy-2-propanol (SP value: 9.98, boiling point: 132 degrees Celsius)
1-propoxy-2-propanol (SP value: 9.82, boiling point: 149 degrees Celsius)
3-methoxy-1-butanol (SP value: 9.98, boiling point: 161 degrees Celsius)
3-methoxy-3-methyl-1-butanol (SP value: 9.64, boiling point: 174 degrees Celsius)
Ethylene glycol mono-methyl ether, SP value; 10.73, boiling point: 124 degrees Celsius
Ethylene glycol mono-butyl ether, SP value; 9.99, boiling point: 171 degrees Celsius

The unit of the SP value is (J/cm³)^{0.5}, and the boiling point of the organic solvent is given at 1 atmospheric pressure.

### Cation-based Polyethylene Wax

AQUACER 840: Oxidized high-density polyethylene wax emulsion (solids content: 35 percent by mass, melting point: 135 degrees Celsius)

### Other Wax

AQUACER 537: Modified paraffin wax emulsion (solids content: 30 percent by mass, melting point: 110 degrees Celsius)
AQUACER 531: Modified polyethylene wax emulsion (solids content: 45 percent by mass, melting point: 130 degrees Celsius)
AQUACER 593: Modified polypropylenen wax emulsion (solids content: 30 percent by mass, melting point: 160 degrees Celsius)

### Other Surfactant

TEGO Wet 270 (polyether-modified siloxane compound (active ingredient: 100 percent by mass), manufactured by Evonik Industries AG)
TEGO Wet 270 is a polyether-modified siloxane compound represented by Chemical Structure III.
SILFACE SAG503A: (polyether-modified siloxane compound (active ingredient: 100 percent by mass, manufactured by Nisshin Chemical Co., Ltd.)
SILFACE SAG503A is a polyether-modified siloxane compound represented by the Chemical Structure V.
Capstone-FS-3100: Polyoxyethylene perfluoroalkyl ether (active ingredient: 100 percent by mass, manufactured by The Chemours Company
Surfynol 465: acetylene glycol compound (active ingredient: 100 percent by mass, manufactured by Nisshin Chemical Co., Ltd.)

### Mildew-Proofing Agent

Proxel GXL: a mildew-proofing agent whose main component is 1,2-benzisothiazolin-3-one, containing dipropylene glycol (active ingredient: 20 percent by mass, manufactured by Avecia)

### Measurement of Ink Properties

For Aqueous Inks 1 to 44, viscosity and pH were measured as described below. DSC measurements were performed on the dried solids of each ink, and the presence or absence of an endothermic peak in the range of 100 to 140 degrees Celsius was confirmed. The results are shown in Tables 7 and 8.

### Measurement of Viscosity

Viscosity of each ink was measured by a viscometer (RE-85L, manufactured by TOKI SANGYO CO., LTD.) at 25 degrees Celsius.

### Measurement of pH

The pH of each ink was measured at 25 degrees Celsius using a pH meter (Model type HM-41X, available from TOA-DKK Corporation).

### DSC Measurement of Dried Solids

To measure the endothermic peak temperature of the ink dried solids obtained by evaporation to dryness, 30 mg of the ink was weighed and analyzed using a DSC-60A Plus equipped with a cooling unit (manufactured by Shimadzu Corporation) under the following heating and cooling program to determine the endothermic peak of the ink dried solids in the range of 100 to 140 degrees Celsius.

### Heating/Cooling Program

The temperature was raised from room temperature to 300 degrees Celsius at a heating rate of 10 degrees Celsius/min, held at 300 degrees Celsius for 5 minutes, and then cooled to 35 degrees Celsius at a cooling rate of 10 degrees Celsius/min. Subsequently, the temperature was raised to 200 degrees Celsius at a heating rate of 10 degrees Celsius/min, and the endothermic peak was measured.

TABLE 8

| | Presence of |
|---|---|
| | endothermic peak |
| Ink property values | between 100 to |

| | | Viscosity | | 140 degrees |
|---|---|---|---|---|
| Ink | Color | (mPa · s) | pH | Celsius |
| Ink | Black | 7.5 | 9.0 | None |
| 1 | | | | |
| Ink | Magenta | 7.4 | 9.1 | None |
| 2 | | | | |
| Ink | Cyan | 7.1 | 9.0 | None |
| 3 | | | | |
| Ink | Yellow | 7.2 | 8.9 | None |
| 4 | | | | |
| Ink | Black | 8.8 | 9.1 | Yes |
| 5 | | | | |
| Ink | Magenta | 8.8 | 9.1 | Yes |
| 6 | | | | |
| Ink | Cyan | 8.2 | 9.2 | Yes |
| 7 | | | | |
| Ink | Yellow | 8.3 | 9.1 | Yes |
| 8 | | | | |
| Ink | Black | 8.1 | 9.4 | Yes |
| 9 | | | | |
| Ink | Magenta | 8.2 | 9.5 | Yes |
| 10 | | | | |
| Ink | Cyan | 7.6 | 9.6 | Yes |
| 11 | | | | |
| Ink | Yellow | 7.7 | 9.5 | Yes |
| 12 | | | | |
| Ink | Black | 7.2 | 9.5 | Yes |
| 13 | | | | |
| Ink | Magenta | 7.5 | 9.5 | Yes |
| 14 | | | | |
| Ink | Cyan | 7.1 | 9.4 | Yes |
| 15 | | | | |
| Ink | Yellow | 7.0 | 9.5 | Yes |
| 16 | | | | |
| Ink | Black | 6.6 | 9.4 | Yes |
| 17 | | | | |
| Ink | Magenta | 6.8 | 9.4 | Yes |
| 18 | | | | |
| Ink | Cyan | 6.8 | 9.5 | Yes |
| 19 | | | | |
| Ink | Yellow | 6.9 | 9.4 | Yes |
| 20 | | | | |
| Ink | Black | 6.8 | 9.0 | Yes |
| 21 | | | | |
| Ink | Magenta | 6.9 | 9.1 | Yes |
| 22 | | | | |
| Ink | Cyan | 6.7 | 9.0 | Yes |
| 23 | | | | |
| Ink | Yellow | 6.9 | 9.1 | Yes |
| 24 | | | | |

TABLE 9

| | Presence of |
|---|---|
| | endothermic peak |
| Ink property values | between 100 to |

| | | Viscosity | | 140 degrees |
|---|---|---|---|---|
| Ink | Color | (mPa · s) | pH | Celsius |
| Ink | Black | 8.3 | 9.5 | Yes |
| 25 | | | | |
| Ink | Magenta | 8.4 | 9.4 | Yes |
| 26 | | | | |
| Ink | Cyan | 8.2 | 9.4 | Yes |
| 27 | | | | |
| Ink | Yellow | 8.0 | 9.4 | Yes |
| 28 | | | | |
| Ink | Black | 6.3 | 9.4 | None |
| 29 | | | | |
| Ink | Magenta | 6.5 | 9.4 | None |
| 30 | | | | |
| Ink | Cyan | 6.5 | 9.5 | None |
| 31 | | | | |
| Ink | Yellow | 7.1 | 9.4 | None |
| 32 | | | | |
| Ink | Black | 7.2 | 8.9 | None |
| 33 | | | | |
| Ink | Magenta | 6.9 | 9.0 | None |
| 34 | | | | |
| Ink | Cyan | 7.1 | 8.8 | None |
| 35 | | | | |
| Ink | Yellow | 7.0 | 9.1 | None |
| 36 | | | | |
| Ink | Black | 7.0 | 9.0 | Yes |
| 37 | | | | |
| Ink | Magenta | 7.1 | 9.2 | Yes |
| 38 | | | | |
| Ink | Cyan | 6.9 | 8.9 | Yes |
| 39 | | | | |
| Ink | Yellow | 7.2 | 9.1 | Yes |
| 40 | | | | |
| Ink | Black | 6.9 | 8.9 | None |
| 41 | | | | |
| Ink | Magenta | 7.0 | 9.0 | None |
| 42 | | | | |
| Ink | Cyan | 6.8 | 8.9 | None |
| 43 | | | | |
| Ink | Yellow | 7.0 | 9.1 | None |
| 44 | | | | |

### Preparation of Pre-Processing Fluid

### Preparation of Pre-Processing Fluid 1

A total of 12.50 parts by mass of magnesium sulfate (manufactured by Tokyo Chemical Industry Co., Ltd.) was weighed into a glass beaker, and 50.00 parts by mass of highly pure water was added, followed by stirring for 5 minutes. Subsequently, 20.00 parts by mass of propylene glycol, 15.00 parts by mass of 1,2-butanediol, 0.50 parts by mass of Surfynol 465, 0.05 parts by mass of a mildew-proofing agent (PROXEL GXL, manufactured by Avecia), and 0.10 parts by mass of 1,2,3-benzotriazole (manufactured by Tokyo Chemical Industry Co., Ltd.) were added, and the mixture was stirred for 15 minutes. Thereafter, highly pure water was added as balance to make the total 100 parts by mass, followed by stirring for 10 minutes. The thus-obtained mixture was filtered with a polyvinilydene fluoride membrane filter having an average pore diameter of 10.0 μm under pressure to remove dust such as insoluble matter to prepare [Pre-processing Fluid 1].

### Preparation of Pre-Processing Fluids 2 to 6

The [Pre-processing Fluid 2] to [Pre-processing Fluid 6] were prepared in the same manner as in Preparation of [Pre-processing Fluid 1] except that the prescription of the pre-processing fluid was changed to materials and the proportions as shown in the following Table 9. The content of each material is represented in percent by mass in Table 9 below. It does not represent the content of solid portion or active ingredient but all included.

TABLE 10

| Material | | | | | |
|---|---|---|---|---|---|
| | | Active | Pre-processing | Pre-processing | Pre-processing |
| Classification | Material name | ingredient | Fluid 1 | Fluid 2 | Fluid 3 |
| Inorganic | Magnesium | 100 | 12.50 | — | — |
| metal salt | nitrate | percent | | | |
| | hexahydrate | | | | |
| | Magnesium | 100 | — | 15.00 | — |
| | chloride | percent | | | |
| | hexahydrate | | | | |
| Organic acid | Ammonium | 40 | — | — | 25.0 |
| ammonium | lactate | percent | | | |
| salt | aqueous | | | | |
| | solution | | | | |
| Organic acid | Magnesium | 100 | — | — | — |
| metal salt | acetate | percent | | | |
| | tetrahydrate | | | | |
| Cationic | SHALLOL ® | 51 | — | — | — |
| polymer | DC-902P | percent | | | |
| | DK8610 | 55 | — | — | — |
| | | percent | | | |
| Organic | 1,2- | 100 | 20.00 | 20.00 | 20.00 |
| solvent | propanediol | percent | | | |
| | 1,2- | 100 | 15.00 | 15.00 | — |
| | butanediol | percent | | | |
| | 3-methyl- | 100 | — | — | 15.00 |
| | 1,3-butane | percent | | | |
| | diol | | | | |
| Surfactant | Surfynol 465 | 100 | 0.50 | 0.50 | 0.50 |
| | | percent | | | |
| Mildew- | Proxel GXL | 20 | 0.05 | 0.05 | 0.05 |
| proofing | | percent | | | |
| agent | | | | | |
| Corrosion | 1,2,3- | 100 | 0.10 | 0.10 | 0.10 |
| Inhibitor | benzotriazole | percent | | | |
| Highly pure water | | | Balance | Balance | Balance |
| Total | | | 100 | 100 | 100 |
| Material | | | | | |
| | | Active | Pre-processing | Pre-processing | Pre-processing |
| Classification | Material name | ingredient | Fluid 4 | Fluid 5 | Fluid 6 |
| Inorganic | Magnesium | 100 | — | — | — |
| metal salt | nitrate | percent | | | |
| | hexahydrate | | | | |
| | Magnesium | 100 | — | — | — |
| | chloride | percent | | | |
| | hexahydrate | | | | |
| Organic acid | Ammonium | 40 | — | — | — |
| ammonium | lactate | percent | | | |
| salt | aqueous | | | | |
| | solution | | | | |
| Organic acid | Magnesium | 100 | 12.50 | — | — |
| metal salt | acetate | percent | | | |
| | tetrahydrate | | | | |
| Cationic | SHALLOL ® | 51 | — | 19.61 | — |
| polymer | DC-902P | percent | | | |
| | DK8610 | 55 | — | — | 22.73 |
| | | percent | | | |
| Organic | 1,2- | 100 | 20.00 | 20.00 | 20.00 |
| solvent | propanediol | percent | | | |
| | 1,2- | 100 | 15.00 | 5.00 | 5.00 |
| | butanediol | percent | | | |
| | 3-methyl- | 100 | — | 10.00 | 10.00 |
| | 1,3-butane | percent | | | |
| | diol | | | | |
| Surfactant | Surfynol 465 | 100 | 0.50 | 0.50 | 0.50 |
| | | percent | | | |
| Mildew- | Proxel GXL | 20 | 0.05 | 0.05 | 0.05 |
| proofing | | percent | | | |
| agent | | | | | |
| Corrosion | 1,2,3- | 100 | 0.10 | 0.10 | 0.10 |
| Inhibitor | benzotriazole | percent | | | |

| | | | |
|---|---|---|---|
| Highly pure water | Balance | Balance | Balance |
| Total | 100 | 100 | 100 |

The details of each material shown in Tables 10 are as follows.

### Cationic Polymer

SHALLOL DC-902P: polydimethyl diallyl ammonium chloride, solid content of 51.0 percent by mass, manufactured by DKS Co., Ltd.
DK6810: polyamine resin, solid content of 55.0 percent by mass, manufactured by SEIKO PMC CORPORATION

### Examples 1 to 14 and Comparative Examples 1 to 8

Image formation was carried out using the various inks and pre-processing fluids shown in Table 11 by the following method, and evaluations were performed for image density, anti-beading property, abrasion resistance, and anti-blocking property.

### Image Density

Under environmental conditions adjusted to 23±0.5 degrees Celsius and 50±5 percent RH, image formation was performed using an image forming apparatus (IPSiO GXe-5500, manufactured by Ricoh Co., Ltd.). The drive voltage of the piezoelectric element was varied so that the amount of the ink discharged was uniform, and the amount of the ink adhered was set to 8±0.5 g/m² on the recording medium OK Top Coat+ (basis weight: 104.7 g/m², manufactured by Oji Paper Co., Ltd.). When a pre-processing liquid was used, its amount adhered was set to 1.1±0.1 g/m².

A chart created in Word 2000 (manufactured by Microsoft Corporation) containing 64-point text “black square: a black square was printed on the recording medium OK Top Coat+ (basis weight: 104.7 g/m², manufactured by Oji Paper Co., Ltd.). The “black square” area on the printed surface was measured using a compact spectrophotometer (eXact, manufactured by X-Rite, Inc.), and the results were evaluated according to the following criteria. The print mode used was a modified mode based on “Plain Paper-High Quality” from the user settings for plain paper in the printer driver, with color correction disabled.

### Evaluation Criterion

A: Black: at least 1.9, Yellow: at least 1.15, Magenta: at least 1.6, Cyan: at least 1.9
B: Black: 0.8 to less than 9; Yellow: at least 1.1 to less than 1.15; Magenta: 1.5 to less than 1.6; Cyan: 1.8 to less than 1.9
C: Black: 1.7 to less than 1.8, Yellow: 1.0 to less than 1.1, Magenta: 1.4 to less than 1.5, Cyan: 1.7 to less than 1.8
D: Black: less than 1.7, Yellow: less than 1.0, Magenta: less than 1.40, Cyan: less than 1.7

### Anti-Beading

The print mode used was a modified mode based on “Glossy Paper-High Quality” in the printer driver, with color correction disabled. Solid images were printed in the same manner as for image density, and density unevenness (beading) of the solid images was visually observed and evaluated according to the following criteria. Since visual observation of black solid images is difficult, they were observed under an optical microscope at 40× magnification.

### Evaluation Criterion

A: None at all
B: Slightly present
C: Fairly observed
D: Severely present

### Abrasion Resistance

The print mode used was a modified mode based on “Glossy Paper-Fast” in the printer driver, with color correction disabled. Solid images were printed in the same manner as for image density and dried for 30 seconds in a natural convection dryer set at an internal temperature of 100 degrees Celsius. The solid images were then rubbed 20 reciprocating cycles using a friction tester (trade name: Crockmeter, manufactured by Toyo Seiki Seisaku-sho, Ltd.) with a blank OK Top Coat+ sheet set on the tester. The stain density on the rubbed blank sheet was measured using a compact spectrophotometer (exact, manufactured by X-Rite, Inc.), and the results were evaluated according to the following criteria. The background fouling density of the recording medium was excluded from the density of the contamination.

### Evaluation Criterion

A: less than 0.1
B: 0.1 to less than 0.3
C: 0.3 to less than 0.5
D: at least 0.5

### Blocking Resistance

The print mode used was a modified mode based on “Glossy Paper-Fast” in the printer driver, with color correction disabled. Solid images were printed in the same manner as for image density and dried for 10 seconds in a natural convection dryer set at an internal temperature of 100 degrees Celsius. The solid image and a blank OK Top Coat+ sheet were then overlaid, subjected to a load of 5 kg/cm², and left to stand for 2 hours under conditions of 25 degrees Celsius and 50 percent RH. After the two hour resting, the overlaid solid image and the white paper were peeled off and the area of the solid image transferred onto the white paper was visually observed to make an evaluation according to the following criteria.

### Evaluation Criterion

A: No transfer observed
B: Minute point image transferred
C: Image slightly transferred
D: Image transferred

TABLE 11

| | | | Im- | | Abra- | |
|---|---|---|---|---|---|---|
| | Pre- | | age | Anti- | sion | |
| | processing | | Den- | Bead- | resis- | Blocking |
| | fluid | Ink | sity | ing | tance | resistance |
| Example 1 | None | Inks 1 | A | B | B | B |
| | | to 4 | | | | |
| Example 2 | None | Inks 5 | A | B | A | B |
| | | to 8 | | | | |
| Example 3 | None | Inks 9 | A | B | A | B |
| | | to 12 | | | | |
| Example 4 | None | Inks 13 | A | A | B | A |
| | | to 16 | | | | |
| Example 5 | None | Inks 17 | A | A | A | A |
| | | to 20 | | | | |
| Example 6 | None | Inks 21 | A | A | A | A |
| | | to 24 | | | | |
| Example 7 | None | Inks 25 | A | A | A | A |
| | | to 28 | | | | |
| Example 8 | Pre- | Inks 1 | A | A | B | B |
| | processing | to 4 | | | | |
| | Fluid 1 | | | | | |
| Example 9 | Pre- | Inks 5 | A | A | A | B |
| | processing | to 8 | | | | |
| | Fluid 2 | | | | | |
| Example 10 | Pre- | Inks 9 | A | A | A | B |
| | processing | to 12 | | | | |
| | Fluid 3 | | | | | |
| Example 11 | Pre- | Inks 13 | A | A | B | A |
| | processing | to 16 | | | | |
| | Fluid 4 | | | | | |
| Example 12 | Pre- | Inks 17 | B | A | A | B |
| | processing | to 20 | | | | |
| | Fluid 5 | | | | | |
| Example 13 | Pre- | Inks 21 | A | A | A | A |
| | processing | to 24 | | | | |
| | Fluid 6 | | | | | |
| Example 14 | Pre- | Inks 25 | A | A | A | A |
| | processing | to 28 | | | | |
| | Fluid 1 | | | | | |
| Comparative | None | Inks 29 | B | A | D | A |
| Example 1 | | to 32 | | | | |
| Comparative | None | Inks 33 | A | A | D | A |
| Example 2 | | to 36 | | | | |
| Comparative | None | Inks 37 | A | A | C | A |
| Example 3 | | to 40 | | | | |
| Comparative | None | Inks 41 | A | A | D | A |
| Example 4 | | to 44 | | | | |
| Comparative | Pre- | Inks 29 | B | A | D | B |
| Example 5 | processing | to 32 | | | | |
| | Fluid 3 | | | | | |
| Comparative | Pre- | Inks 33 | A | A | D | A |
| Example 6 | processing | to 36 | | | | |
| | Fluid 4 | | | | | |
| Comparative | Pre- | Inks 37 | A | A | D | A |
| Example 7 | processing | to 40 | | | | |
| | Fluid 5 | | | | | |
| Comparative | Pre- | Inks 41 | A | A | D | A |
| Example 8 | processing | to 44 | | | | |
| | Fluid 6 | | | | | |

From the results of Examples 1 to 14, it can be seen that using an ink containing cation-based polyethylene wax provides images excellent in image density, anti-beading property, abrasion resistance, and blocking resistance.

On the other hand, from the results of Comparative Examples 1 to 8, it can be seen that when an ink free of cation-based polyethylene wax is used, the abrasion resistance of the formed image decreases.

Aspects of the embodiments of the present invention are, for example, as follows:

### Aspect 1

An ink contains a coloring material that contains a first resin having a glass transition temperature of at most 0 degrees Celsius, a second resin having a glass transition temperature of at least 60 degrees Celsius, a cation-based polyethylene wax, and water, wherein the first resin contains a solid content of 0.5 to 3 percent by mass based on the total amount of the ink and the second resin contains a solid content of 5 to 15 percent by mass based on a total amount of the ink.

### Aspect 2

The ink according to Aspect 1 mentioned above, wherein the cation-based polyethylene wax contains a polyethylene wax having a melting point of 100 to 140 degrees Celsius.

### Aspect 3

The ink according to Aspect 1 or 2 mentioned above, wherein the cation-based polyethylene wax contains a polyethylene wax accounting for 0.1 to 2.0 percent by mass of the ink

### Aspect 4

The ink according to any one of Aspects 1 to 3 mentioned above, wherein the first resin contains a urethane resin.

### Aspect 5

The ink according to any one of Aspects 1 to 4 mentioned above, wherein the second resin contains an acrylic resin.

### Aspect 6

The ink according to any one of Aspects 1 to 5 mentioned above further contains a polyhydric alcohol having a boiling point of at most 200 degrees Celsius at 1 atmospheric pressure.

### Aspect 7

The ink according to any one of Aspects 1 to 6 mentioned above further contains an organic solvent having a solubility parameter of 9 to less than 11.8 (J/cm³)^{0.5}.

### Aspect 8

An ink set contains the ink of any one of Aspects 1 to 7 mentioned above and a pre-processing fluid containing water and a flocculant, wherein the flocculant is selected from the group consisting of an inorganic metal salt, an organic acid metal salt, an organic ammonium salt, and a cationic polymer.

### Aspect 9

An image forming method includes applying at least one member selected from the group consisting of heat, pressure, vibration, and light to the ink of any one of Aspects 1 to 7 mentioned above to jet the ink to form an image.

### Aspect 10

An image forming apparatus includes an inkjetting device for applying at least one member selected from the group consisting of the group consisting of heat, pressure, vibration, and light to the ink of any one of Aspects 1 to 7 mentioned above to jet the ink to form an image.

The above-described embodiments are illustrative and do not limit the present invention. Thus, numerals additional modifications and variations are possible in light of the above-teachings. For example, elements and/or features of difference illustrative embodiments may be combined with each other and/or substituted for each other within the scope of the present invention. Any one of the above-described operations may be performed in various other ways, for example, in an order difference from the one described above.

1. An ink comprising:
a coloring material;
a first resin having a glass transition temperature of at most 0 degrees Celsius;
a second resin having a glass transition temperature of at least 60 degrees Celsius;
a cation-based polyethylene wax; and
water,
wherein the first resin contains a solid content of 0.5 to 3 percent by mass based on a total amount of the ink,
wherein the second resin contains a solid content of 5 to 15 percent by mass based on the total amount of the ink.

2. The ink according to claim 1,
wherein the cation-based polyethylene wax contains a polyethylene wax having a melting point of 100 to 140 degrees Celsius.

3. The ink according to claim 1,
wherein the cation-based polyethylene wax contains a polyethylene wax accounting for 0.1 to 2.0 percent by mass of the ink.

4. The ink according to claim 1, wherein the first resin comprises a urethane resin.

5. The ink according to claim 1, wherein the second resin comprises an acrylic resin.

6. The ink according to claim 1, further comprising a polyhydric alcohol having a boiling point of at most 200 degrees Celsius at 1 atmospheric pressure.

7. The ink according to claim 1, further comprising an organic solvent having a solubility parameter of 9 to less than 11.8 (J/cm³)^{0.5}.

8. An ink set comprising:
the ink of claim 1; and
a pre-processing fluid comprising water and a flocculant selected from the group consisting of an inorganic metal salt, an organic acid metal salt, an organic acid ammonium salt, and a cationic polymer.

9. An image forming method comprising:
applying at least one member selected from the group consisting of pressure, vibration, and light to the ink of claim 1 to jet the ink to form an image.

10. An image forming apparatus comprising:
an inkjetting device configured to apply at least one member selected from the group consisting of heat, pressure, vibration, and light to the ink of claim 1 to jet the ink to form an image.
